(19) United States
(12) Patent Application Publication
(10) Pub. No.: US 2025/0374352 A1
(43) Pub. Date: Dec. 4, 2025

(54) COMMUNICATION LINKS IN WIRELESS COMMUNICATION NETWORKS

(71) Applicant: QUALCOMM Incorporated, San Diego, CA (US)

(72) Inventors: Kapil Rai, Sunnyvale, CA (US); Guido Robert Frederiks, Watsonville, CA (US)

(21) Appl. No.: 18/676,395

(22) Filed: May 28, 2024

(51) Int. Cl. H04W 76/15; H04L 5/00; H04W 88/06

(52) U.S. Cl. CPC H04W 76/15; H04L 5/0055; H04W 88/06

(57) ABSTRACT

This disclosure provides methods, components, devices and systems for providing enhanced frame exchange via multi-link device (MLD) communication links. Some aspects more specifically relate to communicating a first portion of a network traffic connection between MLD enabled Wi-Fi devices via a first communication link between a first MLD on a first network and a first MLD on a second network device. Some aspects also include communicating a second portion of the network traffic connection between the first network device and the second network device via a second communication link between a second MLD on the first network device and a second MLD on the second network device.

### TECHNICAL FIELD

This disclosure relates generally to wireless communications, and more specifically, to providing communication links between multi-link network devices in high interference wireless network environments.

### DESCRIPTION OF THE RELATED TECHNOLOGY

Wireless communication networks may include various types of wireless communication devices including network entities (such as wireless access points (AP) or base stations (BS)), client devices (such as wireless stations (STAs) or user equipment (UEs)), and other wireless nodes. These wireless communication devices may communicate with one another via a variety of technologies and wireless communication protocols, including wireless local area network (WLAN) or Wi-Fi-based protocols or cellular (such as 4G, 5G, or 6G)-based protocols. The wireless communication networks may be capable of supporting communication with multiple users by sharing the available system resources (such as time, frequency, and spatial resources). To enable features or provide improved performance, the wireless communication devices may employ technologies such as orthogonal frequency divisional multiple access (OFDMA), multi-user Multiple-Input Multiple-Output (MU-MIMO), spatial multiplexing, and beamforming. For greater inter-operability, the wireless communication networks may support backwards compatibility (such as supporting legacy wireless communication devices) as well as forward compatibility (such as supporting communication with wireless communication devices compatible with next-generation wireless communication standards).

### SUMMARY

The systems, methods and devices of this disclosure each have several innovative aspects, no single one of which is solely responsible for the desirable attributes disclosed herein.

One innovative aspect of the subject matter described in this disclosure can be implemented in a wireless access point. The wireless access point includes a processing system that includes one or more processors and one or more memories coupled with the one or more processors, the processing system configured to cause the wireless access point to: communicate at least a first portion of a network traffic connection between the wireless access point and a wireless station via a first communication link between a first multi-link device (MLD) on the wireless access point and a first MLD on the wireless station, where the network traffic connection includes downlink (DL) traffic communicated at a first bandwidth to the wireless station, and where the network traffic connection includes uplink (UL) traffic communicated at a second bandwidth from the wireless station, and communicate at least a second portion of the network traffic connection between the wireless access point and the wireless station via a second communication link between a second MLD on the wireless access point and a second MLD on the wireless station.

In some examples, the first portion of the network traffic connection includes: the DL traffic and the UL traffic. In some aspects, the second portion of the network traffic connection includes: duplicated packets representing the DL traffic and duplicated UL traffic representing the UL traffic. In some examples, the first portion of the network traffic connection includes: the DL traffic and the second portion of the network traffic connection includes: the UL traffic.

In some examples, the DL traffic is transmitted to the wireless station on a first physical (PHY) layer, and the UL traffic is received from the wireless station via a second PHY layer.

In some aspects, the wireless access point transmits the DL traffic as unidirectional no acknowledgement (ACK) traffic, and the processing system is further configured to cause the wireless access point to: freeze a backoff time associated with an interference condition in the first communication link, and transmit, during the backoff time, a DL packet over the first communication link.

In some aspects, the processing system is further configured to cause the wireless access point to: retransmit the DL packet over the first communication link when the first communication link is in a retransmit reception state.

In some aspects, the processing system is further configured to cause the wireless access point to: inspect a preamble of a first Overlapping Basic Service Set (OBSS) packet received at the access point and abort reception of the first OBSS packet when the first packet is not destined for the access point. In some examples, the processing system is further configured to continue inspection of preambles of additional packets received at the access point during a OBSS backoff time associated with the first OBSS packet and begin receiving a first packet associated with the UL traffic in the first communication link during the OBSS backoff time associated with the first OBSS packet.

In some examples, the wireless access point transmits the DL traffic as unidirectional no ACK traffic, and the wireless access point communicates the UL traffic via the second communication link using a ping-pong pull network traffic exchange.

In some aspects, the processing system is further configured to cause the wireless access point to: transmit a first portion of a packet preamble to the wireless station via the first communication link, pause a transmission of one or more packets from the wireless access point over the first communication link, and receive a confirmation of successful reception of the first portion of the packet preamble from the wireless station.

In some examples, the first portion of the packet preamble indicates a ping-pong network traffic exchange between the wireless access point and the wireless station for a first packet of the first portion of the network traffic connection, and the processing system is further configured to cause the wireless access point to: transmit the first packet of the first portion of the network traffic connection over the first communication link.

In some aspects, the first portion of the packet preamble indicates a ping-pong pull network traffic exchange between the wireless access point and the wireless station, and the processing system is further configured to cause the wireless access point to: receive a first packet of the second portion of the network traffic connection via the second communication link and from the wireless station associated with the confirmation of the successful reception of the first portion of the packet preamble.

In some examples, the first portion of the packet preamble includes at least: a combination of values in a header rate field and a header length field indicating one of a ping-pong network traffic exchange or a ping-pong pull network traffic exchange between the wireless access point and the wireless station and a reservation portion to reserve a local medium for the ping-pong network traffic exchange or the ping-pong pull network traffic exchange.

In some aspects, the reservation portion includes: a first amount of packet data, where a size of the first amount of the packet data is associated with a round-trip delay between the wireless access point and the wireless station.

In some examples, the first portion includes one or more of: a Cyclic Redundancy Check value in a High Efficiency Signal header field and associated with a round-trip delay between the wireless access point and the wireless station, and a packet extension section to extend an energy of the packet preamble on a medium.

One innovative aspect of the subject matter described in this disclosure can be implemented in a wireless station. The station includes a processing system that includes one or more processors and one or more memories coupled with the one or more processors, the processing system configured to cause the wireless station to: communicate at least a first portion of a network traffic connection between the wireless station and a wireless access point (AP) via a first communication link between a first multi-link device (MLD) on the wireless station and a first MLD on the wireless access point, where the network traffic connection includes downlink (DL) traffic communicated at a first bandwidth from the wireless AP, and where the network traffic connection includes uplink (UL) traffic communicated at a second bandwidth to the wireless AP from the wireless station, and communicate at least a second portion of the network traffic connection between the wireless station and the wireless AP via a second communication link between a second MLD on the wireless station and a second MLD on the wireless AP.

One innovative aspect of the subject matter described in this disclosure can be implemented in method for wireless communication by a wireless communication device. In some examples, the method includes communicating at least a first portion of a network traffic connection between the wireless communication device and a wireless station via a first communication link between a first multi-link device (MLD) on the wireless communication device and a first MLD on the wireless station, where the network traffic connection includes downlink (DL) traffic communicated at a first bandwidth to the wireless station, and where the network traffic connection includes uplink (UL) traffic communicated at a second bandwidth from the wireless station. In some examples, the method also includes communicating at least a second portion of the network traffic connection between the wireless communication device and the wireless station via a second communication link between a second MLD on the wireless communication device and a second MLD on the wireless station.

One innovative aspect of the subject matter described in this disclosure can be implemented in a method for wireless communication by a wireless station. In some examples, the method including: communicating at least a first portion of a network traffic connection between the wireless station and a wireless access point (AP) via a first communication link between a first multi-link device (MLD) on the wireless station and a first MLD on the wireless access point, where the network traffic connection includes downlink (DL) traffic communicated at a first bandwidth from the wireless AP, and where the network traffic connection includes uplink (UL) traffic communicated at a second bandwidth to the wireless AP from the wireless station. In some examples, the method also includes communicating at least a second portion of the network traffic connection between the wireless station and the wireless AP via a second communication link between a second MLD on the wireless station and a second MLD on the wireless AP.

Details of one or more implementations of the subject matter described in this disclosure are set forth in the accompanying drawings and the description below. Other features, aspects, and advantages will become apparent from the description, the drawings and the claims. Note that the relative dimensions of the following figures may not be drawn to scale.

### BRIEF DESCRIPTION OF THE DRAWINGS

FIG. 1 shows a pictorial diagram of an example wireless communication network.

FIG. 2A shows an example protocol data unit (PDU) usable for communications between a wireless access point (AP) and one or more wireless stations (STAs).

FIG. 2B shows an example physical layer (PHY) protocol data unit (PPDU) usable for communications between a wireless AP and one or more wireless STAs.

FIG. 3 shows a hierarchical format of an example PPDU usable for communications between a wireless AP and one or more wireless STAs.

FIG. 4 shows a timing diagram illustrating an example process for performing a ranging operation.

FIG. 5 shows a pictorial diagram of example multi-link devices in a wireless communication network.

FIGS. 6A and 6B show pictorial diagrams of example communication links between multi-link devices in a wireless communication network.

FIGS. 7A and 7B show system flow diagrams illustrating example processes for providing communication links between multi-link network devices in a wireless network.

FIGS. 8A and 8B show system flow diagrams illustrating example processes for providing communication links between multi-link network devices in a wireless network.

FIG. 9 shows a system flow diagram illustrating an example process for providing communication links between multi-link network devices in a wireless network.

FIGS. 10A and 10B show example adjustable packet preambles usable for wireless communication.

FIG. 11 shows a flowchart illustrating an example process performable by or at a wireless AP that supports providing communication links between multi-link network devices in a wireless network.

FIG. 12 shows a flowchart illustrating an example process performable by or at a wireless AP that supports providing communication links between multi-link network devices in a wireless network.

FIG. 13 shows a flowchart illustrating an example process performable by or at a wireless AP that supports providing communication links between multi-link network devices in a wireless network.

FIG. 14 shows a block diagram of an example wireless communication device that supports providing communication links between multi-link network devices in a wireless network.

Like reference numbers and designations in the various drawings indicate like elements.

### DETAILED DESCRIPTION

The following description is directed to some particular examples for the purposes of describing innovative aspects of this disclosure. However, a person having ordinary skill in the art will readily recognize that the teachings herein can be applied in a multitude of different ways. Some or all of the described examples may be implemented in any device, system or network that is capable of transmitting and receiving radio frequency (RF) signals according to one or more of the Institute of Electrical and Electronics Engineers (IEEE) 802.11 standards, the IEEE 802.15 standards, the Bluetooth® standards as defined by the Bluetooth Special Interest Group (SIG), or the Long Term Evolution (LTE), 3G, 4G, 5G (New Radio (NR)) or 6G standards promulgated by the 3^{rd} Generation Partnership Project (3GPP), among others.

The described examples can be implemented in any suitable device, component, system or network that is capable of transmitting and receiving RF signals according to one or more of the following technologies or techniques: code division multiple access (CDMA), time division multiple access (TDMA), orthogonal frequency division multiplexing (OFDM), frequency division multiple access (FDMA), orthogonal FDMA (OFDMA), single-carrier FDMA (SC-FDMA), spatial division multiple access (SDMA), rate-splitting multiple access (RSMA), multi-user shared access (MUSA), single-user (SU) multiple-input multiple-output (MIMO) and multi-user (MU)-MIMO (MU-MIMO). The described examples also can be implemented using other wireless communication protocols or RF signals suitable for use in one or more of a wireless personal area network (WPAN), a wireless local area network (WLAN), a wireless wide area network (WWAN), a wireless metropolitan area network (WMAN), a non-terrestrial network (NTN), or an internet of things (IoT) network.

In some wireless communication networks, a network device in the wireless communication network may experience varying amounts of interference during the duration of a connection to a network. For example, a Wi-Fi based uncrewed aerial vehicle (UAV), or drone may communicate with a controller via Wi-Fi based protocols while in flight. A drone may operate in a variety of environment settings including urban settings, where a large amount of frequent interference from other network devices is expected, suburban settings, where a medium amount of frequent interference is expected, and rural settings, where a low amount of infrequent interference is expected. In some examples, a drone may travel some distance (such as several kilometers) away from a controller device and experience a mixture of each of these settings and related interference. This can lead to communication links with irregular, limited, and asymmetric bandwidths between the drone and the controller device which limits the range or distance between the drone and controller devices.

Various aspects relate generally to wireless communication and more particularly to providing enhanced frame exchange via multi-link device (MLD) communication links. Some aspects more specifically relate to communicating a first portion of a network traffic connection between MLD enabled Wi-Fi devices via a first communication link between a first MLD on a first network device, such as a wireless AP, and a first MLD on a second network device, such as a wireless station. Some aspects also include communicating at least a second portion of the network traffic connection between the first network device and the second network device via a second communication link between a second MLD on the first network device and a second MLD on the second network device. In some examples, the network traffic connection may include downlink (DL) traffic communicated at a first bandwidth to the wireless station, where the network traffic connection includes uplink (UL) traffic communicated at a second bandwidth from the wireless station. In some aspects, the network connection may be communicated using duplicated network traffic, where the first portion of the network traffic connection includes the DL traffic and the UL traffic and where the second portion of the network traffic connection includes duplicated packets representing the DL traffic and duplicated UL traffic representing the UL traffic. In some additional aspects, the DL traffic can be transmitted to the wireless station on a first physical (PHY) layer, and the UL traffic is received from the wireless station via a second PHY layer, where the first portion of the network traffic connection includes the DL traffic; and the second portion of the network traffic connection the UL traffic. In some examples, the dual communication links via MLD devices on the network devices also provide for enhanced frame exchange operations.

Particular aspects of the subject matter described in this disclosure can be implemented to realize one or more of the following potential advantages. In some examples, the use of MLD devices and frame exchanges protocols to provide multiple communication links between networks devices increases the reliability of packet/frame delivery between the network devices by providing an increased ability of network traffic to be delivered successfully independent of distance and interference between the MLD devices. For example, using duplicated packets on dual communication links and using enhanced frame exchanges via dual communication links provides increased communication reliability in high interference environments allowing for increased distance between network devices. For example, the described techniques can be used to provide increased reliability for DL and UL communications between a control device and a UAV that is otherwise range limited in travel distance from a control device. The improved communication links and enhanced frame exchange address asymmetrical budget links in the communication links between UAVs and controllers by increasing the reliable delivery of command and control frames being communicated between the UAV and its related controller without requiring more bandwidth to be allocated to command and control frames.

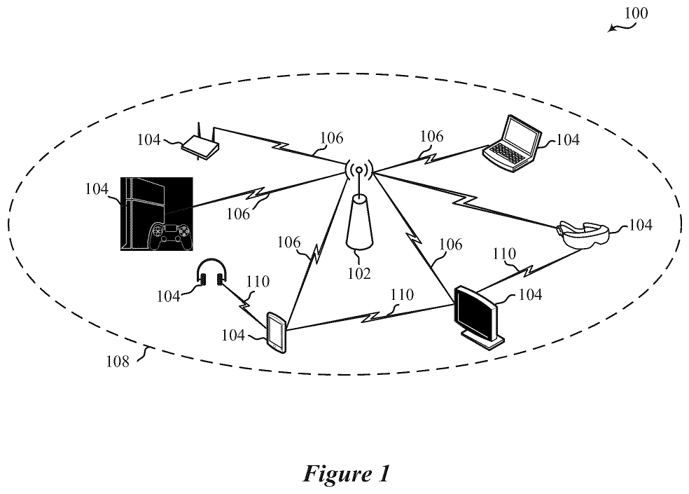

FIG. 1 shows a pictorial diagram of an example wireless communication network 100. According to some aspects, the wireless communication network 100 can be an example of a wireless local area network (WLAN) such as a Wi-Fi network. For example, the wireless communication network 100 can be a network implementing at least one of the IEEE 802.11 family of wireless communication protocol standards, such as defined by the IEEE 802.11-2020 specification or amendments thereof (including, but not limited to, 802.11ay, 802.11ax (also referred to as Wi-Fi 6), 802.11az, 802.11ba, 802.11bc, 802.11bd, 802.11be (also referred to as Wi-Fi 7), 802.11bf, and 802.11bn (also referred to as Wi-Fi 8)) or other WLAN or Wi-Fi standards, such as that associated with the Integrated Millimeter Wave (IMMW) study group. In some other examples, the wireless communication network 100 can be an example of a cellular radio access network (RAN), such as a 5G or 6G RAN that implements one or more cellular protocols such as those specified in one or more 3GPP standards. In some other examples, the wireless communication network 100 can include a WLAN that functions in an interoperable or converged manner with one or more cellular RANs to provide greater or enhanced network coverage to wireless communication devices within the wireless communication network 100 or to enable such devices to connect to a cellular network's core, such as to access the network management capabilities and functionality offered by the cellular network core. In some other examples, the wireless communication network 100 can include a WLAN that functions in an interoperable or converged manner with one or more personal area networks, such as a network implementing Bluetooth or other wireless technologies, to provide greater or enhanced network coverage or to provide or enable other capabilities, functionality, applications or services.

The wireless communication network 100 may include numerous wireless communication devices including a wireless access point (AP) 102 and any number of wireless stations (STAs) 104. While only one AP 102 is shown in FIG. 1, the wireless communication network 100 can include multiple APs 102 (for example, in an extended service set (ESS) deployment, enterprise network or AP mesh network), or may not include any AP at all (for example, in an independent basic service set (IBSS) such as a peer-to-peer (P2P) network or other ad hoc network). The AP 102 can be or represent various different types of network entities including, but not limited to, a home networking AP, an enterprise-level AP, a single-frequency AP, a dual-band simultaneous (DBS) AP, a tri-band simultaneous (TBS) AP, a standalone AP, a non-standalone AP, a software-enabled AP (soft AP), and a multi-link AP (also referred to as an AP multi-link device (MLD)), as well as cellular (such as 3GPP, 4G LTE, 5G or 6G) base stations or other cellular network nodes such as a Node B, an evolved Node B (eNB), a gNB, a transmission reception point (TRP) or another type of device or equipment included in a radio access network (RAN), including Open-RAN (O-RAN) network entities, such as a central unit (CU), a distributed unit (DU) or a radio unit (RU).

Each of the STAs 104 also may be referred to as a mobile station (MS), a mobile device, a mobile handset, a wireless handset, an access terminal (AT), a user equipment (UE), a subscriber station (SS), or a subscriber unit, among other examples. The STAs 104 may represent various devices such as mobile phones, other handheld or wearable communication devices, netbooks, notebook computers, tablet computers, laptops, Chromebooks, augmented reality (AR), virtual reality (VR), mixed reality (MR) or extended reality (XR) wireless headsets or other peripheral devices, wireless earbuds, other wearable devices, display devices (for example, TVs, computer monitors or video gaming consoles), video game controllers, navigation systems, music or other audio or stereo devices, remote control devices, printers, kitchen appliances (including smart refrigerators) or other household appliances, key fobs (for example, for passive keyless entry and start (PKES) systems), Internet of Things (IoT) devices, and vehicles, among other examples.

A single AP 102 and an associated set of STAs 104 may be referred to as an infrastructure basic service set (BSS), which is managed by the respective AP 102. FIG. 1 additionally shows an example coverage area 108 of the AP 102, which may represent a basic service area (BSA) of the wireless communication network 100. The BSS may be identified by STAs 104 and other devices by a service set identifier (SSID), as well as a basic service set identifier (BSSID), which may be a medium access control (MAC) address of the AP 102. The AP 102 may periodically broadcast beacon frames (“beacons”) including the BSSID to enable any STAs 104 within wireless range of the AP 102 to “associate” or re-associate with the AP 102 to establish a respective communication link 106 (hereinafter also referred to as a “Wi-Fi link”), or to maintain a communication link 106, with the AP 102. For example, the beacons can include an identification or indication of a primary channel used by the respective AP 102 as well as a timing synchronization function (TSF) for establishing or maintaining timing synchronization with the AP 102. The AP 102 may provide access to external networks to various STAs 104 in the wireless communication network 100 via respective communication links 106.

To establish a communication link 106 with an AP 102, each of the STAs 104 is configured to perform passive or active scanning operations (“scans”) on frequency channels in one or more frequency bands (for example, the 2.4 GHz, 5 GHZ, 6 GHZ, 45 GHZ, or 60 GHz bands). To perform passive scanning, a STA 104 listens for beacons, which are transmitted by respective APs 102 at periodic time intervals referred to as target beacon transmission times (TBTTs). To perform active scanning, a STA 104 generates and sequentially transmits probe requests on each channel to be scanned and listens for probe responses from APs 102. Each STA 104 may identify, determine, ascertain, or select an AP 102 with which to associate in accordance with the scanning information obtained through the passive or active scans, and to perform authentication and association operations to establish a communication link 106 with the selected AP 102. The selected AP 102 assigns an association identifier (AID) to the STA 104 at the culmination of the association operations, which the AP 102 uses to track the STA 104.

As a result of the increasing ubiquity of wireless networks, a STA 104 may have the opportunity to select one of many BSSs within range of the STA 104 or to select among multiple APs 102 that together form an extended service set (ESS) including multiple connected BSSs. For example, the wireless communication network 100 may be connected to a wired or wireless distribution system that may enable multiple APs 102 to be connected in such an ESS. As such, a STA 104 can be covered by more than one AP 102 and can associate with different APs 102 at different times for different transmissions. Additionally, after association with an AP 102, a STA 104 also may periodically scan its surroundings to find a more suitable AP 102 with which to associate. For example, a STA 104 that is moving relative to its associated AP 102 may perform a “roaming” scan to find another AP 102 having more desirable network characteristics such as a greater received signal strength indicator (RSSI) or a reduced traffic load.

In some examples, STAs 104 may form networks without APs 102 or other equipment other than the STAs 104 themselves. One example of such a network is an ad hoc network (or wireless ad hoc network). Ad hoc networks may alternatively be referred to as mesh networks or peer-to-peer (P2P) networks. In some examples, ad hoc networks may be implemented within a larger network such as the wireless communication network 100. In such examples, while the STAs 104 may be capable of communicating with each other through the AP 102 using communication links 106, STAs 104 also can communicate directly with each other via direct wireless communication links 110. Additionally, two STAs 104 may communicate via a direct wireless communication link 110 regardless of whether both STAs 104 are associated with and served by the same AP 102. In such an ad hoc system, one or more of the STAs 104 may assume the role filled by the AP 102 in a BSS. Such a STA 104 may be referred to as a group owner (GO) and may coordinate transmissions within the ad hoc network. Examples of direct wireless communication links 110 include Wi-Fi Direct connections, connections established by using a Wi-Fi Tunneled Direct Link Setup (TDLS) link, and other P2P group connections.

In some networks, the AP 102 or the STAs 104, or both, may support applications associated with high throughput or low-latency requirements, or may provide lossless audio to one or more other devices. For example, the AP 102 or the STAs 104 may support applications and use cases associated with ultra-low-latency (ULL), such as ULL gaming, or streaming lossless audio and video to one or more personal audio devices (such as peripheral devices) or AR/VR/MR/XR headset devices. In scenarios in which a user uses two or more peripheral devices, the AP 102 or the STAs 104 may support an extended personal audio network enabling communication with the two or more peripheral devices. Additionally, the AP 102 and STAs 104 may support additional ULL applications such as cloud-based applications (such as VR cloud gaming) that have ULL and high throughput requirements.

As indicated above, in some implementations, the AP 102 and the STAs 104 may function and communicate (via the respective communication links 106) according to one or more of the IEEE 802.11 family of wireless communication protocol standards. These standards define the WLAN radio and baseband protocols for the physical (PHY) and MAC layers. The AP 102 and STAs 104 transmit and receive wireless communications (hereinafter also referred to as “Wi-Fi communications” or “wireless packets”) to and from one another in the form of PHY protocol data units (PPDUs).

Each PPDU is a composite structure that includes a PHY preamble and a payload that is in the form of a PHY service data unit (PSDU). The information provided in the preamble may be used by a receiving device to decode the subsequent data in the PSDU. In instances in which a PPDU is transmitted over a bonded or wideband channel, the preamble fields may be duplicated and transmitted in each of multiple component channels. The PHY preamble may include both a legacy portion (or “legacy preamble”) and a non-legacy portion (or “non-legacy preamble”). The legacy preamble may be used for packet detection, automatic gain control and channel estimation, among other uses. The legacy preamble also may generally be used to maintain compatibility with legacy devices. The format of, coding of, and information provided in the non-legacy portion of the preamble is associated with the particular IEEE 802.11 wireless communication protocol to be used to transmit the payload.

The APs 102 and STAs 104 in the wireless communication network 100 may transmit PPDUs over an unlicensed spectrum, which may be a portion of spectrum that includes frequency bands traditionally used by Wi-Fi technology, such as the 2.4 GHz, 5 GHZ, 6 GHZ, 45 GHz, and 60 GHz bands. Some examples of the APs 102 and STAs 104 described herein also may communicate in other frequency bands that may support licensed or unlicensed communications. For example, the APs 102 or STAs 104, or both, also may be capable of communicating over licensed operating bands, where multiple operators may have respective licenses to operate in the same or overlapping frequency ranges. Such licensed operating bands may map to or be associated with frequency range designations of FR1 (410 MHz-7.125 GHz), FR2 (24.25 GHz-52.6 GHz), FR3 (7.125 GHz-24.25 GHz), FR4a or FR4-1 (52.6 GHz-71 GHz), FR4 (52.6 GHz-114.25 GHz), and FR5 (114.25 GHz-300 GHz).

Each of the frequency bands may include multiple sub-bands and frequency channels (also referred to as subchannels). The terms “channel” and “subchannel” may be used interchangeably herein, as each may refer to a portion of frequency spectrum within a frequency band (for example, a 20 MHz, 40 MHz, 80 MHz, or 160 MHz portion of frequency spectrum) via which communication between two or more wireless communication devices can occur. For example, PPDUs conforming to the IEEE 802.11n, 802.11ac, 802.11ax, 802.11be and 802.11bn standard amendments may be transmitted over one or more of the 2.4 GHz, 5 GHZ, or 6 GHz bands, each of which is divided into multiple 20 MHz channels. As such, these PPDUs are transmitted over a physical channel having a minimum bandwidth of 20 MHz, but larger channels can be formed through channel bonding. For example, PPDUs may be transmitted over physical channels having bandwidths of 40 MHz, 80 MHz, 160 MHz, 240 MHz, 320 MHZ, 480 MHz, or 640 MHz by bonding together multiple 20 MHz channels.

An AP 102 may determine or select an operating or operational bandwidth for the STAs 104 in its BSS and select a range of channels within a band to provide that operating bandwidth. For example, the AP 102 may select sixteen 20 MHz channels that collectively span an operating bandwidth of 320 MHz. Within the operating bandwidth, the AP 102 may typically select a single primary 20 MHz channel on which the AP 102 and the STAs 104 in its BSS monitor for contention-based access schemes. In some examples, the AP 102 or the STAs 104 may be capable of monitoring only a single primary 20 MHz channel for packet detection (for example, for detecting preambles of PPDUs). Conventionally, any transmission by an AP 102 or a STA 104 within a BSS must involve transmission on the primary 20 MHz channel. As such, in conventional systems, the transmitting device must contend on and win a TXOP on the primary channel to transmit anything at all. However, some APs 102 and STAs 104 supporting ultra-high reliability (UHR) communications or communication according to the IEEE 802.11bn standard amendment can be configured to operate, monitor, contend and communicate using multiple primary 20 MHz channels. Such monitoring of multiple primary 20 MHz channels may be sequential such that responsive to determining, ascertaining or detecting that a first primary 20 MHz channel is not available, a wireless communication device may switch to monitoring and contending using a second primary 20 MHz channel. Additionally, or alternatively, a wireless communication device may be configured to monitor multiple primary 20 MHz channels in parallel. In some examples, a first primary 20 MHz channel may be referred to as a main primary (M-Primary) channel and one or more additional, second primary channels may each be referred to as an opportunistic primary (O-Primary) channel. For example, if a wireless communication device measures, identifies, ascertains, detects, or otherwise determines that the M-Primary channel is busy or occupied (such as due to an overlapping BSS (OBSS) transmission), the wireless communication device may switch to monitoring and contending on an O-Primary channel. In some examples, the M-Primary channel may be used for beaconing and serving legacy client devices and an O-Primary channel may be specifically used by non-legacy (for example, UHR- or IEEE 802.11bn-compatible) devices for opportunistic access to spectrum that may be otherwise under-utilized.

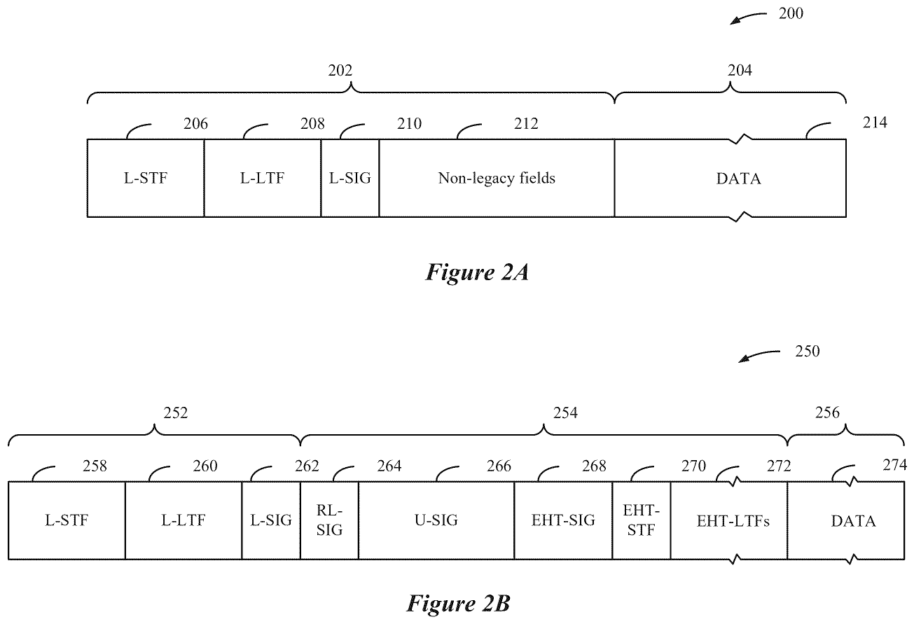

FIG. 2A shows an example protocol data unit (PDU) 200 usable for wireless communication between a wireless AP and one or more wireless STAs. For example, the AP and STAs may be examples of the AP 102 and the STAs 104 described with reference to FIG. 1. The PDU 200 can be configured as a PPDU. As shown, the PDU 200 includes a PHY preamble 202 and a PHY payload 204. For example, the preamble 202 may include a legacy portion that itself includes a legacy short training field (L-STF) 206, which may consist of two symbols, a legacy long training field (L-LTF) 208, which may consist of two symbols, and a legacy signal field (L-SIG) 210, which may consist of two symbols. The legacy portion of the preamble 202 may be configured according to the IEEE 802.11a wireless communication protocol standard. The preamble 202 also may include a non-legacy portion including one or more non-legacy fields 212, for example, conforming to one or more of the IEEE 802.11 family of wireless communication protocol standards.

The L-STF 206 generally enables a receiving device (such as an AP 102 or a STA 104) to perform coarse timing and frequency tracking and automatic gain control (AGC). The L-LTF 208 generally enables the receiving device to perform fine timing and frequency tracking and also to perform an initial estimate of the wireless channel. The L-SIG 210 generally enables the receiving device to determine (for example, obtain, select, identify, detect, ascertain, calculate, or compute) a duration of the PDU and to use the determined duration to avoid transmitting on top of the PDU. The legacy portion of the preamble, including the L-STF 206, the L-LTF 208 and the L-SIG 210, may be modulated according to a binary phase shift keying (BPSK) modulation scheme. The payload 204 may be modulated according to a BPSK modulation scheme, a quadrature BPSK (Q-BPSK) modulation scheme, a quadrature amplitude modulation (QAM) modulation scheme, or another appropriate modulation scheme. The payload 204 may include a PSDU including a data field (DATA) 214 that, in turn, may carry higher layer data, for example, in the form of MAC protocol data units (MPDUs) or an aggregated MPDU (A-MPDU).

FIG. 2B shows an example physical layer (PHY) protocol data unit (PPDU) 250 usable for communications between a wireless AP and one or more wireless STAs. For example, the AP and STAs may be examples of the AP 102 and the STAs 104 described with reference to FIG. 1. As shown, the PPDU 250 includes a PHY preamble, that includes a legacy portion 252 and a non-legacy portion 254, and a payload 256 that includes a data field 274. The legacy portion 252 of the preamble includes an L-STF 258, an L-LTF 260, and an L-SIG 262. The non-legacy portion 254 of the preamble includes a repetition of L-SIG (RL-SIG) 264 and multiple wireless communication protocol version-dependent signal fields after RL-SIG 264. For example, the non-legacy portion 254 may include a universal signal field 266 (referred to herein as “U-SIG 266”) and an EHT signal field 268 (referred to herein as “EHT-SIG 268”). The presence of RL-SIG 264 and U-SIG 266 may indicate to EHT- or later version-compliant STAs 104 that the PPDU 250 is an EHT PPDU or a PPDU conforming to any later (post-EHT) version of a new wireless communication protocol conforming to a future IEEE 802.11 wireless communication protocol standard. One or both of U-SIG 266 and EHT-SIG 268 may be structured as, and carry version-dependent information for, other wireless communication protocol versions associated with amendments to the IEEE family of standards beyond EHT. For example, U-SIG 266 may be used by a receiving device (such as an AP 102 or a STA 104) to interpret bits in one or more of EHT-SIG 268 or the data field 274. Like L-STF 258, L-LTF 260, and L-SIG 262, the information in U-SIG 266 and EHT-SIG 268 may be duplicated and transmitted in each of the component 20 MHz channels in instances involving the use of a bonded channel.

The non-legacy portion 254 further includes an additional short training field 270 (referred to herein as “EHT-STF 270,” although it may be structured as, and carry version-dependent information for, other wireless communication protocol versions beyond EHT) and one or more additional long training fields 272 (referred to herein as “EHT-LTFs 272,” although they may be structured as, and carry version-dependent information for, other wireless communication protocol versions beyond EHT). EHT-STF 270 may be used for timing and frequency tracking and AGC, and EHT-LTF 272 may be used for more refined channel estimation.

EHT-SIG 268 may be used by an AP 102 to identify and inform one or multiple STAs 104 that the AP 102 has scheduled uplink (UL) or downlink (DL) resources for them. EHT-SIG 268 may be decoded by each compatible STA 104 served by the AP 102. EHT-SIG 268 may generally be used by the receiving device to interpret bits in the data field 274. For example, EHT-SIG 268 may include resource unit (RU) allocation information, spatial stream configuration information, and per-user (for example, STA-specific) signaling information. Each EHT-SIG 268 may include a common field and at least one user-specific field. In the context of OFDMA, the common field can indicate RU distributions to multiple STAs 104, indicate the RU assignments in the frequency domain, indicate which RUs are allocated for MU-MIMO transmissions and which RUs correspond to OFDMA transmissions, and the number of users in allocations, among other examples. The user-specific fields are assigned to particular STAs 104 and carry STA-specific scheduling information such as user-specific MCS values and user-specific RU allocation information. Such information enables the respective STAs 104 to identify and decode corresponding RUs in the associated data field 274.

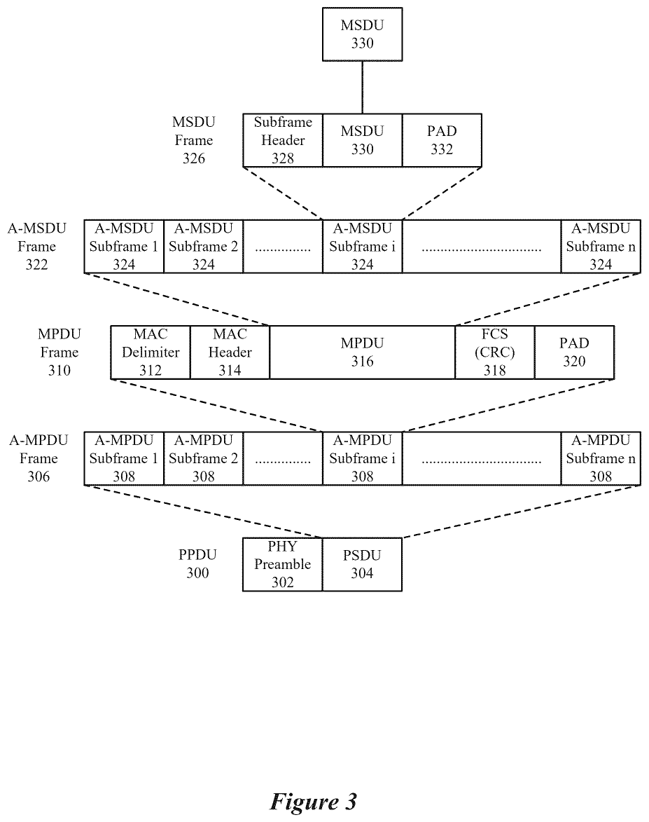

FIG. 3 shows a hierarchical format of an example PPDU usable for communications between a wireless AP and one or more wireless STAs. For example, the AP and STAs may be examples of the AP 102 and the STAs 104 described with reference to FIG. 1. As described, each PPDU 300 includes a PHY preamble 302 and a PSDU 304. Each PSDU 304 may represent (or “carry”) one or more MAC protocol data units (MPDUs) 316. For example, each PSDU 304 may carry an aggregated MPDU (A-MPDU) 306 that includes an aggregation of multiple A-MPDU subframes 308. Each A-MPDU subframe 306 may include an MPDU frame 310 that includes a MAC delimiter 312 and a MAC header 314 prior to the accompanying MPDU 316, which includes the data portion (“payload” or “frame body”) of the MPDU frame 310. Each MPDU frame 310 also may include a frame check sequence (FCS) field 318 for error detection (for example, the FCS field 318 may include a cyclic redundancy check (CRC)) and padding bits 320. The MPDU 316 may carry one or more MAC service data units (MSDUs) 316. For example, the MPDU 316 may carry an aggregated MSDU (A-MSDU) 322 including multiple A-MSDU subframes 324. Each A-MSDU subframe 324 may be associated with an MSDU frame 326 and may contain a corresponding MSDU 330 preceded by a subframe header 328 and, in some examples, followed by padding bits 332.

Referring back to the MPDU frame 310, the MAC delimiter 312 may serve as a marker of the start of the associated MPDU 316 and indicate the length of the associated MPDU 316. The MAC header 314 may include multiple fields containing information that defines or indicates characteristics or attributes of data encapsulated within the frame body. The MAC header 314 includes a duration field indicating a duration extending from the end of the PPDU until at least the end of an acknowledgment (ACK) or Block ACK (BA) of the PPDU that is to be transmitted by the receiving wireless communication device. The use of the duration field serves to reserve the wireless medium for the indicated duration, and enables the receiving device to establish its network allocation vector (NAV). The MAC header 314 also includes one or more fields indicating addresses for the data encapsulated within the frame body. For example, the MAC header 314 may include a combination of a source address, a transmitter address, a receiver address or a destination address. The MAC header 314 may further include a frame control field containing control information. The frame control field may specify a frame type, for example, a data frame, a control frame, or a management frame.

In some wireless communication systems, wireless communication between an AP 102 and an associated STA 104 can be secured. For example, either an AP 102 or a STA 104 may establish a security key for securing wireless communication between itself and the other device and may encrypt the contents of the data and management frames using the security key. In some examples, the control frame and fields within the MAC header of the data or management frames, or both, also may be secured either via encryption or via an integrity check (for example, by generating a message integrity check (MIC) for one or more relevant fields).

Access to the shared wireless medium is generally governed by a distributed coordination function (DCF). With a DCF, there is generally no centralized master device allocating time and frequency resources of the shared wireless medium. On the contrary, before a wireless communication device, such as an AP 102 or a STA 104, is permitted to transmit data, it may wait for a particular time and contend for access to the wireless medium. The DCF is implemented through the use of time intervals (including the slot time (or “slot interval”) and the inter-frame space (IFS). IFS provides priority access for control frames used for proper network operation. Transmissions may begin at slot boundaries. Different varieties of IFS exist including the short IFS (SIFS), the distributed IFS (DIFS), the extended IFS (EIFS), and the arbitration IFS (AIFS). The values for the slot time and IFS may be provided by a suitable standard specification, such as one or more of the IEEE 802.11 family of wireless communication protocol standards.

In some examples, the wireless communication device (such as the AP 102 or the STA 104) may implement the DCF through the use of carrier sense multiple access (CSMA) with collision avoidance (CA) (CSMA/CA) techniques. According to such techniques, before transmitting data, the wireless communication device may perform a clear channel assessment (CCA) and may determine (for example, identify, detect, ascertain, calculate, or compute) that the relevant wireless channel is idle. The CCA includes both physical (PHY-level) carrier sensing and virtual (MAC-level) carrier sensing. Physical carrier sensing is accomplished via a measurement of the received signal strength of a valid frame, which is compared to a threshold to determine (for example, identify, detect, ascertain, calculate, or compute) whether the channel is busy. For example, if the received signal strength of a detected preamble is above a threshold, the medium is considered busy. Physical carrier sensing also includes energy detection. Energy detection involves measuring the total energy the wireless communication device receives regardless of whether the received signal represents a valid frame. If the total energy detected is above a threshold, the medium is considered busy.

Virtual carrier sensing is accomplished via the use of a network allocation vector (NAV), which effectively serves as a time duration that elapses before the wireless communication device may contend for access even in the absence of a detected symbol or even if the detected energy is below the relevant threshold. The NAV is reset each time a valid frame is received that is not addressed to the wireless communication device. When the NAV reaches 0, the wireless communication device performs the physical carrier sensing. If the channel remains idle for the appropriate IFS, the wireless communication device initiates a backoff timer, which represents a duration of time that the device senses the medium to be idle before it is permitted to transmit. If the channel remains idle until the backoff timer expires, the wireless communication device becomes the holder (or “owner”) of a transmit opportunity (TXOP) and may begin transmitting. The TXOP is the duration of time the wireless communication device can transmit frames over the channel after it has “won” contention for the wireless medium. The TXOP duration may be indicated in the U-SIG field of a PPDU. If, on the other hand, one or more of the carrier sense mechanisms indicate that the channel is busy, a MAC controller within the wireless communication device will not permit transmission.

Each time the wireless communication device generates a new PPDU for transmission in a new TXOP, it randomly selects a new backoff timer duration. The available distribution of the numbers that may be randomly selected for the backoff timer is referred to as the contention window (CW). There are different CW and TXOP durations for each of the four access categories (ACs): voice (AC_VO), video (AC_VI), background (AC_BK), and best effort (AC_BE). This enables particular types of traffic to be prioritized in the network.

In some other examples, the wireless communication device (for example, the AP 102 or the STA 104) may contend for access to the wireless medium of the wireless communication network 100 in accordance with an enhanced distributed channel access (EDCA) procedure. A random channel access mechanism such as EDCA may afford high-priority traffic a greater likelihood of gaining medium access than low-priority traffic. The wireless communication device using EDCA may classify data into different access categories. Each AC may be associated with a different priority level and may be assigned a different range of random backoffs (RBOs) so that higher priority data is more likely to win a TXOP than lower priority data (such as by assigning lower RBOs to higher priority data and assigning higher RBOs to lower priority data). Although EDCA increases the likelihood that low-latency data traffic will gain access to a shared wireless medium during a given contention period, unpredictable outcomes of medium access contention operations may prevent low-latency applications from achieving certain levels of throughput or satisfying certain latency requirements.

APs and STAs (for example, the AP 102 and the STAs 104 described with reference to FIG. 1) that include multiple antennas may support various diversity schemes. For example, spatial diversity may be used by one or both of a transmitting device (such as either AP 102 or STA 104) or a receiving device (such as an AP 102 or a STA 104) to increase the robustness of a transmission. For example, to implement a transmit diversity scheme, a transmitting device may transmit the same data redundantly over two or more antennas.

APs 102 and STAs 104 that include multiple antennas also may support space-time block coding (STBC). With STBC, a transmitting device also transmits multiple copies of a data stream across multiple antennas to exploit the various received versions of the data to increase the likelihood of decoding the correct data. More specifically, the data stream to be transmitted is encoded in blocks, which are distributed among the spaced antennas and across time. Generally, STBC can be used when the number N_{Tx} of transmit antennas exceeds the number N_{SS} of spatial streams. The N_{SS} spatial streams may be mapped to a number NSTs of space-time streams, which are mapped to N_{Tx} transmit chains.

APs 102 and STAs 104 that include multiple antennas also may support spatial multiplexing, which may be used to increase the spectral efficiency and the resultant throughput of a transmission. To implement spatial multiplexing, the transmitting device divides the data stream into a number N_{SS} of separate, independent spatial streams. The spatial streams are separately encoded and transmitted in parallel via the multiple N_{Tx} transmit antennas.

APs 102 and STAs 104 that include multiple antennas also may support beamforming. Beamforming generally refers to the steering of the energy of a transmission in the direction of a target receiver. Beamforming may be used both in a single-user (SU) context, for example, to improve a signal-to-noise ratio (SNR), as well as in a multi-user (MU) context, for example, to enable MU-MIMO transmissions (also referred to as spatial division multiple access (SDMA)). In the MU-MIMO context, beamforming may additionally or alternatively involve the nulling out of energy in the directions of other receiving devices. To perform SU beamforming or MU-MIMO, a transmitting device, referred to as the beamformer, transmits a signal from each of multiple antennas. The beamformer configures the amplitudes and phase shifts between the signals transmitted from the different antennas such that the signals add constructively along particular directions towards the intended receiver (referred to as the beamformee) or add destructively in other directions towards other devices to mitigate interference in a MU-MIMO context. The manner in which the beamformer configures the amplitudes and phase shifts depends on channel state information (CSI) associated with the wireless channels over which the beamformer intends to communicate with the beamformee.

To obtain the CSI necessary for beamforming, the beamformer may perform a channel sounding procedure with the beamformee. For example, the beamformer may transmit one or more sounding signals (for example, in the form of a null data packet (NDP)) to the beamformee. An NDP is a PPDU without any data field. The beamformee may perform measurements for each of the N_{Tx}×N_{Rx} sub-channels corresponding to all of the transmit antenna and receive antenna pairs associated with the sounding signal. The beamformee generates a feedback matrix associated with the channel measurements and, typically, compresses the feedback matrix before transmitting the feedback to the beamformer. The beamformer may generate a precoding (or “steering”) matrix for the beamformee associated with the feedback and use the steering matrix to precode the data streams to configure the amplitudes and phase shifts for subsequent transmissions to the beamformee. The beamformer may use the steering matrix to determine (for example, identify, detect, ascertain, calculate, or compute) how to transmit a signal on each of its antennas to perform beamforming. For example, the steering matrix may be indicative of a phase shift, or a power level, to use to transmit a respective signal on each of the beamformer's antennas.

When performing beamforming, the transmitting beamforming array gain is logarithmically proportional to the ratio of N_{Tx} to N_{SS}. As such, it is generally desirable, within other constraints, to increase the number N_{Tx} of transmit antennas when performing beamforming to increase the gain. It is also possible to more accurately direct transmissions or nulls by increasing the number of transmit antennas. This is especially advantageous in MU transmission contexts in which it is particularly important to reduce inter-user interference.

To increase an AP 102's spatial multiplexing capability, an AP 102 may need to support an increased number of spatial streams (such as up to 16 spatial streams). However, supporting additional spatial streams may result in increased CSI feedback overhead. Implicit CSI acquisition techniques may avoid CSI feedback overhead by taking advantage of the assumption that the UL and DL channels have reciprocal impulse responses (that is, that there is channel reciprocity). For example, the CSI feedback overhead may be reduced using an implicit channel sounding procedure such as an implicit beamforming report (BFR) technique (such as where STAs 104 transmit NDP sounding packets in the UL while the AP 102 measures the channel) because no BFRs are sent. Once the AP 102 receives the NDPs, it may implicitly assess the channels for each of the STAs 104 and use the channel assessments to configure steering matrices. In order to mitigate hardware mismatches that could break the channel reciprocity on the UL and DL (such as the baseband-to-RF and RF-to-baseband chains not being reciprocal), the AP 102 may implement a calibration method to compensate for the mismatch between the UL and the DL channels. For example, the AP 102 may select a reference antenna, transmit a pilot signal from each of its antennas, and estimate baseband-to-RF gain for each of the non-reference antennas relative to the reference antenna.

In some examples, multiple APs 102 may simultaneously transmit signaling or communications to a single STA 104 utilizing a distributed MU-MIMO scheme. Examples of such a distributed MU-MIMO transmission include coordinated beamforming (CBF) and joint transmission (JT). With CBF, signals (such as data streams) for a given STA 104 may be transmitted by only a single AP 102. However, the coverage areas of neighboring APs may overlap, and signals transmitted by a given AP 102 may reach the STAs in OBSSs associated with neighboring APs as OBSS signals. CBF allows multiple neighboring APs to transmit simultaneously while minimizing or avoiding interference, which may result in more opportunities for spatial reuse. More specifically, using CBF techniques, an AP 102 may beamform signals to in-BSS STAs 104 while forming nulls in the directions of STAs in OBSSs such that any signals received at an OBSS STA are of sufficiently low power to limit the interference at the STA. To accomplish this, an inter-BSS coordination set may be defined between the neighboring APs, which contains identifiers of all APs and STAs participating in CBF transmissions.

With JT, signals for a given STA 104 may be transmitted by multiple coordinated APs 102. For the multiple APs 102 to concurrently transmit data to a STA 104, the multiple APs 102 may all need a copy of the data to be transmitted to the STA 104. Accordingly, the APs 102 may need to exchange the data among each other for transmission to a STA 104. With JT, the combination of antennas of the multiple APs 102 transmitting to one or more STAs 104 may be considered as one large antenna array (which may be represented as a virtual antenna array) used for beamforming and transmitting signals. In combination with MU-MIMO techniques, the multiple antennas of the multiple APs 102 may be able to transmit data via multiple spatial streams. Accordingly, each STA 104 may receive data via one or more of the multiple spatial streams.

In some implementations, the AP 102 and STAs 104 can support various multi-user communications; that is, concurrent transmissions from one device to each of multiple devices (for example, multiple simultaneous downlink communications from an AP 102 to corresponding STAs 104), or concurrent transmissions from multiple devices to a single device (for example, multiple simultaneous uplink transmissions from corresponding STAs 104 to an AP 102). As an example, in addition to MU-MIMO, the AP 102 and STAs 104 may support OFDMA. OFDMA is in some aspects a multi-user version of OFDM.

In OFDMA schemes, the available frequency spectrum of the wireless channel may be divided into multiple resource units (RUs) each including multiple frequency subcarriers (also referred to as “tones”). Different RUs may be allocated or assigned by an AP 102 to different STAs 104 at particular times. The sizes and distributions of the RUs may be referred to as an RU allocation. In some examples, RUs may be allocated in 2 MHz intervals, and as such, the smallest RU may include 26 tones consisting of 24 data tones and 2 pilot tones. Consequently, in a 20 MHz channel, up to 9 RUs (such as 2 MHZ, 26-tone RUs) may be allocated (because some tones are reserved for other purposes). Similarly, in a 160 MHz channel, up to 74 RUs may be allocated. Other tone RUs also may be allocated, such as 52 tone, 106 tone, 242 tone, 484 tone and 996 tone RUs. Adjacent RUs may be separated by a null subcarrier (such as a DC subcarrier), for example, to reduce interference between adjacent RUs, to reduce receiver DC offset, and to avoid transmit center frequency leakage.

For UL MU transmissions, an AP 102 can transmit a trigger frame to initiate and synchronize an UL OFDMA or UL MU-MIMO transmission from multiple STAs 104 to the AP 102. Such trigger frames may thus enable multiple STAs 104 to send UL traffic to the AP 102 concurrently in time. A trigger frame may address one or more STAs 104 through respective association identifiers (AIDs), and may assign each AID (and thus each STA 104) one or more RUs that can be used to send UL traffic to the AP 102. The AP also may designate one or more random access (RA) RUs that unscheduled STAs 104 may contend for.

Some APs and STAs, such as, for example, the AP 102 and STAs 104 described with reference to FIG. 1, are capable of multi-link operation (MLO). For example, the AP 102 and STAs 104 may support MLO as defined in one or both of the IEEE 802.11be and 802.11bn standard amendments. An MLO-capable device may be referred to as a multi-link device (MLD). In some examples, MLO supports establishing multiple different communication links (such as a first link on the 2.4 GHz band, a second link on the 5 GHz band, and the third link on the 6 GHz band) between MLDs. Each communication link may support one or more sets of channels or logical entities. For example, an AP MLD may set, for each of the communication links, a respective operating bandwidth, one or more respective primary channels, and various BSS configuration parameters. An MLD may include a single upper MAC entity, and can include, for example, three independent lower MAC entities and three associated independent PHY entities for respective links in the 2.4 GHz, 5 GHZ, and 6 GHz bands. This architecture may enable a single association process and security context. An AP MLD may include multiple APs 102 each configured to communicate on a respective communication link with a respective one of multiple STAs 104 of a non-AP MLD (also referred to as a “STA MLD”).

To support MLO techniques, an AP MLD and a STA MLD may exchange MLO capability information (such as supported aggregation types or supported frequency bands, among other information). In some examples, the exchange of information may occur via a beacon frame, a probe request frame, a probe response frame, an association request frame, an association response frame, another management frame, a dedicated action frame, or an operating mode indicator (OMI), among other examples. In some examples, an AP MLD may designate a specific channel of one link in one of the bands as an anchor channel on which it transmits beacons and other control or management frames periodically. In such examples, the AP MLD also may transmit shorter beacons (such as ones which may contain less information) on other links for discovery or other purposes.

MLDs may exchange packets on one or more of the communications links dynamically and, in some instances, concurrently. MLDs also may independently contend for access on each of the communication links, which achieves latency reduction by enabling the MLD to transmit its packets on the first communication link that becomes available. For example, “alternating multi-link” may refer to an MLO mode in which an MLD may listen on two or more different high-performance links and associated channels concurrently. In an alternating multi-link mode of operation, an MLD may alternate between use of two links to transmit portions of its traffic. Specifically, an MLD with buffered traffic may use the first link on which it wins contention and obtains a TXOP to transmit the traffic. While such an MLD may in some examples be capable of transmitting or receiving on only one communication link at any given time, having access opportunities via two different links enables the MLD to avoid congestion, reduce latency, and maintain throughput.

Multi-link aggregation (MLA) (which also may be referred to as carrier aggregation (CA)) is another MLO mode in which an MLD may simultaneously transmit or receive traffic to or from another MLD via multiple communication links in parallel such that utilization of available resources may be increased to achieve higher throughput. That is, during at least some duration of time, transmissions or portions of transmissions may occur over two or more communication links in parallel at the same time. In some examples, the parallel communication links may support synchronized transmissions. In some other examples, or during some other durations of time, transmissions over the communication links may be parallel, but not be synchronized or concurrent. Additionally, in some examples or durations of time, two or more of the communication links may be used for communications between MLDs in the same direction (such as all uplink or all downlink), while in some other examples or durations of time, two or more of the communication links may be used for communications in different directions (for example, one or more communication links may support uplink communications and one or more communication links may support downlink communications). In such examples, at least one of the MLDs may operate in a full duplex mode.

MLA may be packet-based or flow-based. For packet-based aggregation, frames of a single traffic flow (such as all traffic associated with a given traffic identifier (TID)) may be transmitted concurrently across multiple communication links. For flow-based aggregation, each traffic flow (such as all traffic associated with a given TID) may be transmitted using a single respective one of multiple communication links. As an example, a single STA MLD may access a web browser while streaming a video in parallel. Per the above example, the traffic associated with the web browser access may be communicated over a first communication link while the traffic associated with the video stream may be communicated over a second communication link in parallel (such that at least some of the data may be transmitted on the first channel concurrently with data transmitted on the second channel). In some other examples, MLA may be implemented with a hybrid of flow-based and packet-based aggregation. For example, an MLD may employ flow-based aggregation in situations in which multiple traffic flows are created and may employ packet-based aggregation in other situations. Switching among the MLA techniques or modes may additionally, or alternatively, be associated with other metrics (such as a time of day, traffic load within the network, or battery power for a wireless communication device, among other factors or considerations).

Other MLO techniques may be associated with traffic steering and QoS characterization, which may achieve latency reduction and other QoS enhancements by mapping traffic flows having different latency or other requirements to different links. For example, traffic with low latency requirements may be mapped to communication links operating in the 6 GHz band and more latency-tolerant flows may be mapped to communication links operating in the 2.4 GHz or 5 GHz bands. Such an operation, referred to as TID-to-Link mapping (TTLM), may enable two MLDs to negotiate mapping of certain traffic flows in the DL direction or the UL direction or both directions to one or more set of communication links set up between them. In some examples, an AP MLD may advertise a global TTLM that applies to all associated non-AP MLDs. A communication link that has no TIDs mapped to it in either direction is referred to as a disabled link. An enabled link has at least one TID mapped to it in at least one direction.

In some examples, an MLD may include multiple radios and each communication link associated with the MLD may be associated with a respective radio of the MLD. Each radio may include one or more of its own transmit/receive (Tx/Rx) chains, include or be coupled with one or more of its own physical antennas or shared antennas, and include signal processing components, among other components. An MLD with multiple radios that may be used concurrently for MLO may be referred to as a multi-link multi-radio (MLMR) MLD. Some MLMR MLDs may further be capable of an enhanced MLMR (eMLMR) mode of operation, in which the MLD may be capable of dynamically switching radio resources (such as antennas or RF frontends) between multiple communication links (for example, switching from using radio resources for one communication link to using the radio resources for another communication link) to enable higher transmission and reception using higher capacity on a given communication link. In this eMLMR mode of operation, MLDs may be able to move Tx/Rx radio resources from one communication link to another link, thereby increasing the spatial stream capability of the other communication link. For example, if a non-AP MLD includes four or more STAs, the STAs associated with the eMLMR links may “pool” their antennas so that each of the STAs can utilize the antennas of other STAs when transmitting or receiving on one of the eMLMR links.

Other MLDs may have more limited capabilities and not include multiple radios. An MLD with only a single radio that is shared for multiple communication links may be referred to as a multi-link single radio (MLSR) MLD. Control frames may be exchanged between MLDs before initiating data or management frame exchanges between the MLDs in cases in which at least one of the MLDs is operating as an MLSR MLD. Because an MLD operating in the MLSR mode is limited to a single radio, it cannot use multiple communication links simultaneously and may instead listen to (for example, monitor), transmit or receive on only a single communication link at any given time. An MLSR MLD may instead switch between different bands in a TDM manner. In contrast, some MLSR MLDs may further be capable of an enhanced MLSR (eMLSR) mode of operation, in which the MLD can concurrently listen on multiple links for specific types of packets, such as buffer status report poll (BSRP) frames or multi-user (MU) request-to-send (RTS) (MU-RTS) frames. Although an MLD operating in the eMLSR mode can still transmit or receive on only one of the links at any given time, it may be able to dynamically switch between bands, resulting in improvements in both latency and throughput. For example, when the STAs of a non-AP MLD may detect a BSRP frame on their respective communication links, the non-AP MLD may tune all of its antennas to the communication link on which the BSRP frame is detected. By contrast, a non-AP MLD operating in the MLSR mode can only listen to, and transmit or receive on, one communication link at any given time.

An MLD that is capable of simultaneous transmission and reception on multiple communication links may be referred to as a simultaneous transmission and reception (STR) device. In a STR-capable MLD, a radio associated with a communication link can independently transmit or receive frames on that communication link without interfering with, or without being interfered with by, the operation of another radio associated with another communication link of the MLD. For example, an MLD with a suitable filter may simultaneously transmit on a 2.4 GHz band and receive on a 5 GHz band, or vice versa, or simultaneously transmit on the 5 GHz band and receive on the 6 GHz band, or vice versa, and as such, be considered a STR device for the respective paired communication links. Such an STR-capable MLD may generally be an AP MLD or a higher-end STA MLD having a higher performance filter. An MLD that is not capable of simultaneous transmission and reception on multiple communication links may be referred to as a non-STR (NSTR) device. A radio associated with a given communication link in an NSTR device may experience interference when there is a transmission on another communication link of the NSTR device. For example, an MLD with a standard filter may not be able to simultaneously transmit on a 5 GHz band and receive on a 6 GHz band, or vice versa, and as such, may be considered a NSTR device for those two communication links.

In some wireless communication systems, an MLD may include multiple non-collocated entities. For example, an AP MLD may include non-collocated AP devices and a STA MLD may include non-collocated STA devices. In examples in which an AP MLD includes multiple non-collocated AP devices, a single mobility domain (SMD) entity may refer to a logical entity that controls the associated non-collocated APs. A non-AP STA (such as a non-MLD non-AP STA or a non-AP MLD that includes one or more associated non-AP STAs) may associate with the SMD entity via one of its constituent APs and may seamlessly roam (such as without requiring reassociation) between the APs associated with the SMD entity. The SMD entity also may maintain other context (such as security and Block ACK) for non-AP STAs associated with it.

The afore-mentioned and related MLO techniques may provide multiple benefits to a wireless communication network 100. For example, MLO may improve user perceived throughput (UPT) (such as by quickly flushing per-user transmit queues). Similarly, MLO may improve throughput by improving utilization of available channels and may increase spectral utilization (such as increasing the bandwidth-time product). Further, MLO may enable smooth transitions between multi-band radios (such as where each radio may be associated with a given RF band) or enable a framework to set up separation of control channels and data channels. Other benefits of MLO include reducing the “on” time of a modem, which may benefit a wireless communication device in terms of power consumption. Another benefit of MLO is the increased multiplexing opportunities in the case of a single BSS. For example, MLA may increase the number of users per multiplexed transmission served by the multi-link AP MLD.

A wireless communication device may include an auxiliary radio and a main radio and may operate in both an auxiliary radio mode and a main radio mode. The wireless communication device may be a STA or an AP, such as, for example, the AP 102 and STAs 104 described with reference to FIG. 1. Additionally, the wireless communication device may support communications over a single wireless link or over multiple wireless links. For example, the wireless communication device may be an AP MLD or a non-AP MLD. The auxiliary radio mode may support communications with relatively lower data rates (such as ≤24 Mbps) than the main radio mode. For example, while operating in an auxiliary radio mode, the auxiliary radio of the wireless communication device may transmit messages having a non-high throughput (non-HT) format whereas, while operating in a main radio mode, the main radio may transmit messages having an EHT, UHR or later protocol format. A wireless communication device that uses an auxiliary radio in addition to a main radio may improve reliability and reduce latency and power consumption. For example, the wireless communication device may improve reliability by using the auxiliary radio to transmit/receive redundancies, facilitate fast feedback exchanges, or otherwise increase robustness for high-priority or otherwise important packets (for example, packets containing latency-sensitive traffic or traffic requiring high reliability). For example, to support latency-sensitive traffic insertion in uplink communications, an AP may utilize its auxiliary radio for detection of low latency PPDU (LL-PPDU) subframes associated with latency-sensitive traffic. As another example, the wireless communication device also may use the auxiliary radio to scan for channels while communicating on another channel via the main radio, thereby reducing latency associated with a transition between channels by eliminating the time for the main radio to scan for channels. As another example, use of the auxiliary radio may reduce power consumption by enabling the main radio to enter a sleep mode and monitoring for wake-up signals via the auxiliary radio, which is designed to consume less power than the main radio.

The auxiliary radio may support both transmitting and receiving (Tx/Rx) modes of operation, or may support receiving-only (Rx-only) modes of operation. If the wireless communication device is an MLD, the wireless communication device may communicate on one or more wireless links using a main radio and may simultaneously communicate on one or more wireless links using one or more auxiliary radios. In an MLD scenario in which the auxiliary radio is Rx-only capable (an “Aux-Rx” mode), the wireless communication device may transmit and receive communications on a first wireless link using the main radio but may simultaneously receive (but not transmit) communications on a second wireless link using the auxiliary radio. In an MLD scenario in which the auxiliary radio is Tx/Rx capable (an “Aux-Tx/Rx” mode), the wireless communication device may transmit and receive communications on a first wireless link using the main radio and may simultaneously transmit and receive communications on a second wireless link using the auxiliary radio. In an MLD scenario, the wireless communication device may transition the main radio from a second wireless link to a first wireless link and may correspondingly transition the auxiliary radio from the first wireless link to the second wireless link. For example, the wireless communication device's auxiliary radio may receive control signaling on the second wireless link from another wireless communication device that triggers the wireless communication device to switch the use of its radios between wireless links. If the wireless communication device is not an MLD, the wireless communication device may transition from using its auxiliary radio to using its main radio mode on a single wireless link. For example, the wireless communication device's auxiliary radio may receive control signaling from another wireless communication device that triggers the wireless communication device to initiate the transition from use of the auxiliary radio to the main radio on the wireless link. Upon such a transition, the wireless communication device may place the auxiliary radio in a powered-down sleep state while activating the main radio to an awake state. Similarly, the wireless communication may transition from using its main radio to its auxiliary radio on the wireless link upon receiving a triggering control signal.

In some examples, the wireless communication device (such as a STA) may indicate (for example, via a broadcast frame such as a beacon frame or other management frame), to other wireless communication devices (such as an AP), parameters associated with an auxiliary radio mode or parameters associated with transitioning from the auxiliary radio mode to a main radio mode for a given wireless link. For example, the wireless communication device may indicate a message format for the auxiliary radio mode. The indicated message format may be associated with a particular PPDU format (such as non-HT) or a supported data rate (such as ≤24 Mbps).

In some examples, the wireless communication device may indicate transition delays corresponding to time durations associated with switching from the auxiliary mode to the main radio mode as well as switching from the main radio mode to the auxiliary radio mode for a wireless link. A second wireless communication device may schedule data communications with the wireless communication device based on the transition delay so that data is not transmitted to the wireless communication device during the transition delay, during which data may be lost. The duration of the transition delay may generally be dependent on whether the auxiliary radio supports Tx/Rx or Rx-only modes of operation. For example, if the auxiliary radio supports Tx/Rx, the auxiliary radio may transmit an acknowledgment message in response to a request to transition to the main radio mode for a wireless link, which may extend the transition delay. Additionally or alternatively, the duration of the transition delay may depend on whether the main radio is transitioning from a sleep mode or from a different wireless link.

The auxiliary radio may perform additional functions while the wireless communication device communicates with a second wireless communication device via a wireless link using the main radio. The particular functions that may be performed may generally depend on whether the auxiliary radio supports Tx/Rx or Rx-only modes of operation or whether the wireless communication device is an MLD capable of supporting communications over more than one wireless link. For example, in an Aux-Rx mode, the auxiliary radio of a wireless communication device (such as a non-AP MLD) may monitor or collect channel state (or quality) information or statistics (such as BSS load, interference profiles of neighboring BSSs and multi-NAV multi-primary maintenance) in a passive manner. In an Aux Tx/Rx mode, the auxiliary radio of the non-AP MLD may monitor or collect channel state information or statistics as well as transmit a report to an AP MLD that includes the collected channel state information or statistics without involvement of the main radio. In some examples, while operating in an Aux-Rx mode, a first wireless communication device (such as an AP MLD) may use the auxiliary radio to receive control communications or high-priority or otherwise important data communications from the second wireless communication device (such as another AP MLD) using a second wireless link while its main radio uses the first wireless link to perform data transfer. In contrast, in an Aux-Tx/Rx mode, an AP MLD may use the auxiliary radio to both receive and transmit control communications or high-priority or otherwise important data communications. In some examples, while operating in an Aux-Rx mode, a non-AP MLD's auxiliary radio may monitor or scan for potential APs to associate with on alternative wireless channels than the wireless channel on which the non-AP MLD's main radio is still communicating with a previously connected AP. In an Aux-Tx/Rx mode, an MLD may use the auxiliary radio to both scan for and perform association or authentication on other wireless channels.

Aspects of transmissions may vary according to a distance between a transmitter (for example, an AP 102 or a STA 104) and a receiver (for example, another AP 102 or STA 104). Wireless communication devices (such as the AP 102 or the STA 104) may generally benefit from having information regarding the location or proximities of the various STAs 104 within the coverage area. In some examples, relevant distances may be determined (for example, calculated or computed) using RTT-based ranging procedures. Additionally, in some examples, APs 102 and STAs 104 may perform ranging operations. Each ranging operation may involve an exchange of fine timing measurement (FTM) frames (such as those defined in the 802.11az amendment to the IEEE family of wireless communication protocol standards) to obtain measurements of RTT transmissions between the wireless communication devices.

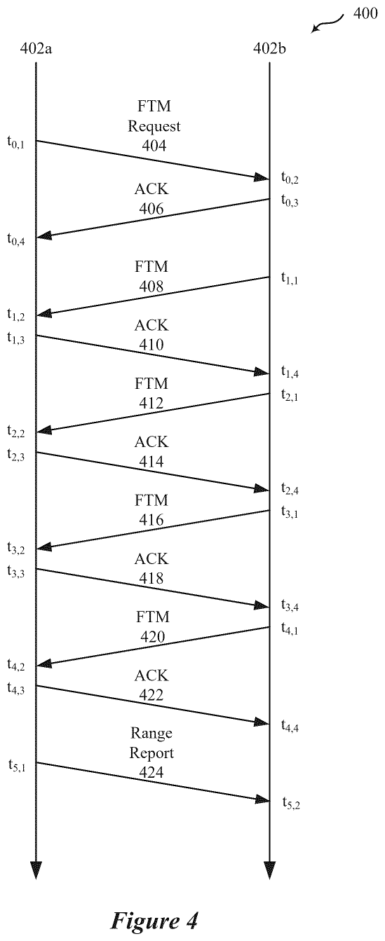

FIG. 4 shows a timing diagram illustrating an example process for performing a ranging operation 400. The process for the ranging operation 400 may be conjunctively performed by two wireless communication devices, such as a first wireless communication device 402a and a second wireless communication device 402b, in accordance with the IEEE 802.11REVme standards, which may each be an example of an AP 102 or a STA 104.

The ranging operation 400 may begin with the first wireless communication device 402a transmitting an initial FTM range request frame 404 at time t_{0,1}. Responsive to successfully receiving the FTM range request frame 404 at time t_{0,2}, the second wireless communication device 402b responds by transmitting a first ACK 406 at time t_{0,3}, which the first wireless communication device 402a receives at time t_{0,4}. The first wireless communication device 402a and the second wireless communication device 402b exchange one or more FTM bursts, which may each include multiple exchanges of FTM action frames (hereinafter simply “FTM frames”) and corresponding ACKs. One or more of the FTM range request frame 404 and the FTM action frames (hereinafter simply “FTM frames”) may include FTM parameters specifying various characteristics of the ranging operation 400.

In the example shown in FIG. 4, in a first exchange, beginning at time t_{1,1}, the second wireless communication device 402b transmits a first FTM frame 408. The second wireless communication device 402b records the time t_{1,1} as the time of departure (TOD) of the first FTM frame 408. The first wireless communication device 402a receives the first FTM frame 408 at time t_{1,2} and transmits a first acknowledgment frame (ACK) 410 to the second wireless communication device 402b at time t_{1,3}. The first wireless communication device 402a records the time t_{1,2} as the time of arrival (TOA) of the first FTM frame 408, and the time t_{1,3} as the TOD of the first ACK 410. The second wireless communication device 402b receives the first ACK 410 at time t_{1,4} and records the time t_{1,4} as the TOA of the first ACK 410.

Similarly, in a second exchange, beginning at time t_{2,1}, the second wireless communication device 402b transmits a second FTM frame 412. The second FTM frame 412 includes a first field indicating the TOD of the first FTM frame 408 and a second field indicating the TOA of the first ACK 410. The first wireless communication device 402a receives the second FTM frame 412 at time t_{2,2} and transmits a second ACK 414 to the second wireless communication device 402b at time t_{2,3}. The second wireless communication device 402b receives the second ACK 414 at time t_{2,4}. Similarly, in a third exchange, beginning at time t_{3,1}, the second wireless communication device 402b transmits a third FTM frame 416. The third FTM frame 416 includes a first field indicating the TOD of the second FTM frame 412 and a second field indicating the TOA of the second ACK 414. The first wireless communication device 402a receives the third FTM frame 416 at time t_{3,2} and transmits a third ACK 418 to the second wireless communication device 402b at time t_{3,3}. The second wireless communication device 402b receives the third ACK 418 at time t_{3,4}. Similarly, in a fourth exchange, beginning at time t_{4,1}, the second wireless communication device 402b transmits a fourth FTM frame 420. The fourth FTM frame 420 includes a first field indicating the TOD of the third FTM frame 416 and a second field indicating the TOA of the third ACK 418. The first wireless communication device 402a receives the fourth FTM frame 420 at time t_{4,2} and transmits a fourth ACK 422 to the second wireless communication device 402b at time t_{4,3}. The second wireless communication device 402b receives the fourth ACK 422 at time t_{4,4}.

The first wireless communication device 402a determines (for example, obtains, identifies, ascertains, calculates, or computes) a range indication in accordance with the TODs and TOAs. For example, in implementations or instances in which an FTM burst includes four exchanges of FTM frames, the first wireless communication device 402a may determine (for example, obtain, identify, ascertain, calculate, or compute) a round trip time (RTT) between itself and the second wireless communication device 402b in accordance with Equation 1.

$$RTT = \frac{1}{3} ( {\sum }_{k = 1}^{3} {t}_{4 , k} - {\sum }_{k = 1}^{3} {t}_{1 , k} ) - ( {\sum }_{k = 1}^{3} {t}_{3 , k} - {\sum }_{k = 1}^{3} {t}_{2 , k} ) \qquad ( 1 )$$

In some implementations, the range indication is the RTT. Additionally or alternatively, in some implementations, the first wireless communication device 402a may determine (for example, obtain, identify, ascertain, calculate, or compute) an actual approximate distance between itself and the second wireless communication device 402b, for example, by multiplying the RTT by an approximate speed of light in the wireless medium. In such instances, the range indication may additionally or alternatively include the distance value. Additionally or alternatively, the range indication may include an indication as to whether the second wireless communication device 402b is within a proximity (for example, a service discovery threshold) of the first wireless communication device 402a in accordance with the RTT. In some implementations, the first wireless communication device 402a may transmit the range indication to the second wireless communication device 402b, for example, in a range report 424 at time t_{5,1}, which the second wireless communication device receives at time t_{5,2}.

Some processes, methods, operations, techniques or other aspects described herein may be implemented, at least in part, using an artificial intelligence (AI) program, such as a program that includes a machine learning (ML) or artificial neural network (ANN) model, hereinafter referred to generally as an AI/ML model. One or more AI/ML models may be implemented in wireless communication devices (for example, APs 102 and STAs 104) and to enhance various aspects associated with wireless communication. For example, an AI/ML model may be trained to identify patterns or relationships in data observed in a wireless communication network 100. An AI/ML model may support operational decisions relating to aspects associated with wireless communications networks or services. For example, an AI/ML model may be utilized for supporting or improving aspects such as reducing signaling overhead (such as by CSI feedback compression, etc.), enhancing roaming or other mobility operations, multi-AP coordination, and generally facilitating network management or optimizing network connections or characteristics to, for example, increase throughput or capacity, reduce latency or otherwise enhance user experience.

An example AI/ML model may include mathematical representations or define computing capabilities for making inferences from input data based on patterns or relationships identified in the input data. As used herein, the term “inferences” can include one or more of decisions, predictions, determinations, or values, which may represent outputs of the AI/ML model. The computing capabilities may be defined in terms of certain parameters of the AI/ML model, such as weights and biases. Weights may indicate relationships between certain input data and certain outputs of the AI/ML model, and biases are offsets that may indicate a starting point for outputs of the AI/ML model. An example AI/ML model operating on input data may start at an initial output based on the biases and then update the output based on a combination of the input data and the weights.

STAs or APs (for example, a STA 104 or an AP 102) may exchange local observations with other wireless communication devices (such as other STAs or APs) or provide feedback related to the communication. This may significantly expand the types of input data that can be considered as input to an AI/ML model, as such information may not otherwise be available at the other wireless communication devices. For example, information received from other STAs or APs may include observed RSSI values, experienced packet success/failure/retry rates per client/AP, BSS/Quality of Service (QOS) load/requirements, or a history of bad/good AP link(s), which may be conveyed in terms of scores or rankings.

AI/ML models can be centralized, distributed, or federated. As both STAs 104 and APs 102 can participate in AI/ML based operations, efficient AI/ML model distribution may enhance the performance of a wireless communication system. In some examples supporting centralized AI/ML models, STAs 104 may provide training data to a centralized network location (such as an AP, AP MLD, or a server) where a global AI/ML model may be generated and refined. The centralized network location may distribute the global AI/ML model to various STAs. In some examples, global AI/ML models may train a single classifier based on all training data received from various inputs/sources. In some examples supporting distributed learning or distributed models, both APs and STAs may be independently capable of computing AI/ML models and sharing data with other participating wireless communication devices in the wireless communication network such that each device can train the global AI/ML model locally. In some examples supporting a federated learning or hybrid AI/ML model, substantially all participating wireless communication devices (such as AP 102s and STA 104s) may be capable of generating local AI/ML models and sharing their local models to a centralized network location or entity. In turn, the centralized network entity may generate a global AI/ML model using the received local models as input and distribute the global model to all or a subset of the participating wireless communication devices.

In some examples, AI/ML models may be downloadable. For example, an AP may share AI/ML model components with associated STAs or other friendly/coordinating APs. STAs may download the AI/ML model and use the model for making decisions related to wireless communications. The downloading of an AI/ML model may be independent from signaling the inputs to the AI/ML model (for example, some wireless communication devices may download the AI/ML model without exchanging information with other wireless communication devices; some wireless communication devices may exchange information and use such information as an input to the AI/ML model without downloading it; and some wireless communication devices may download the AI/ML model and exchange information or the AI/ML model with other wireless communication devices).

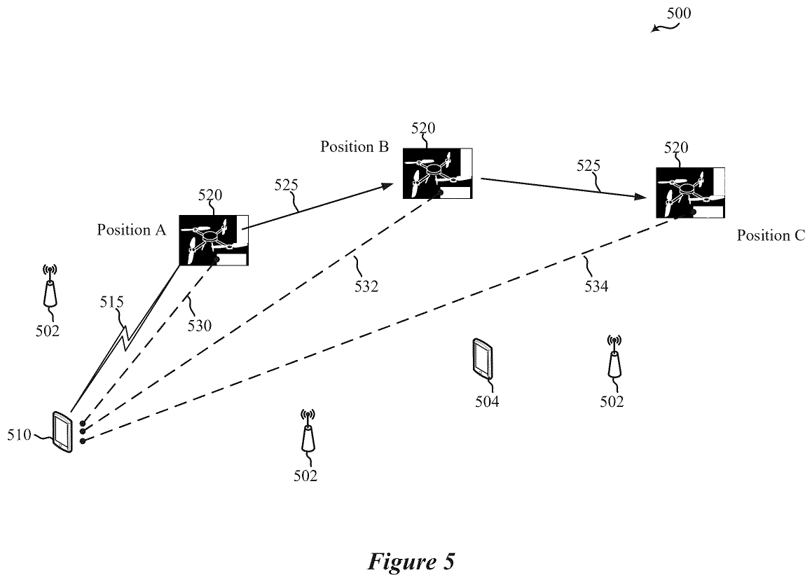

FIG. 5 shows a pictorial diagram of example multi-link devices in a wireless communication network 500. According to some aspects, the wireless communication network 500 can be an example of a WLAN such as a Wi-Fi network as described above in relation to the wireless communication network 100. The wireless communication network 500 includes a controller device 510 and an uncrewed aerial vehicle device (UAV) 520. In some examples, the controller device 510 and the UAV 520 support MLO between the devices and include MLD devices, such as multi-radios and other hardware to provide for multiple communication links between the controller device 510 and the UAV 520. In some aspects, the UAV 520 operates as a wireless AP, such as the APs 102 in the wireless communication network 100, described with reference to FIG. 1, and the controller device 510 operates as a wireless STA device, such as STAs 104 described with reference to FIG. 1. In another example, the functions are switched and the controller device 510 operates as an AP and the UAV 520 operates as a STA. In some aspects, while the examples described in relation FIGS. 5-13 relate to a controller device and an UAV device in in the wireless communication network 500, other various types of APs, such as the APs 102, and STAs, such as the STAs 104, may perform the example operations and methods described herein.

In some examples, the UAV 520 communicates with the controller device 510 via the communication link, where the communication link 515 is similar to the communication link 106 described with reference to FIG. 1. In some example operations, a large amount of network traffic is DL traffic from the UAV 520 to the controller device 510. For example, DL traffic may include video, photos, device status data, and other data generated at the UAV 520 and of interest to a user of the controller device 510. In contrast, UL traffic from the controller device 510 to the UAV 520 primarily includes command and control frames for controlling the flight of the UAV 520.

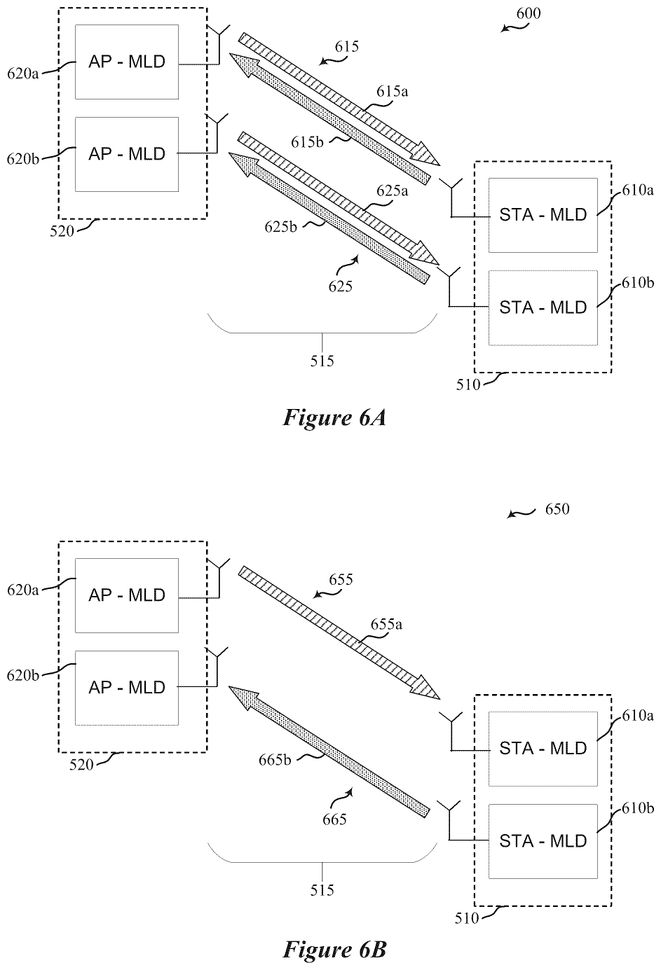

In some examples, the communication link 515 persists as the UAV 520 travels along direction of travel 525 from position A to position B and to position C. For example, at position A the UAV 520 is at a distance 530 from the controller device 510 and proceeds along the direction of travel 525 to a distance 532 from the controller device 510 at position B and a distance 534 from the controller device 510 at position C. In each of these positions the communication link 515 may experience varying levels of interference from interfering network devices such as APs 502 and STAs 504. The increased distance and interference may lead to asymmetry between the UL and DL link-budgets in the communication link 515 and prevent the UAV 520 from remaining under control of the controller device 510. This asymmetry may be increased interference and errors in UL control traffic at larger distances such as distance 534 and in the presence of more interfering devices. To provide reliable communication links between the devices, including the controller device 510 and the UAV 520, both perform the communication operations described in FIGS. 6A to 13.

FIGS. 6A and 6B show pictorial diagrams of example communication links between multi-link devices in a wireless communication network. In some aspects, the UAV 520 and controller device 510, operating as MLO capable devices, utilize multiple physical layer links as the communication link 515. For example, as shown in both configuration 600 and configuration 650, the UAV 520 may communicate at least a first portion of a network traffic connection between the UAV 520 and the controller device 510 via a first communication link between a first MLD 620a on the UAV 520 and a first MLD 610a on the controller device 510. In some examples, the network traffic connection includes DL traffic communicated at a first bandwidth to the controller device 510, and the network traffic connection includes UL traffic communicated at a second bandwidth from the controller device 510. In some examples, the first bandwidth is different from the second bandwidth. For example, the first bandwidth for the DL traffic from the UAV 520 is greater than the second bandwidth for UL traffic from the controller device 510.

In some aspects, the UAV 520 also communicates at least a second portion of the network traffic connection between the UAV 520 and the controller device 510 via a second communication link between a second MLD 620b on the UAV 520 and a second MLD 610b on the controller device 510. In the configuration 600 shown in FIG. 6A, the first portion of the network traffic connection on a communication link 615 between MLD 610a and MLD 620a includes DL traffic 615a and UL traffic 615b. In some examples, the DL traffic 615a has a large bandwidth, such as a bandwidth between 500 kilobits per second (kbps)-50 megabits per second (Mbps) and the UL traffic 615b has a smaller bandwidth such as 50 kpbs-150 kpbs.

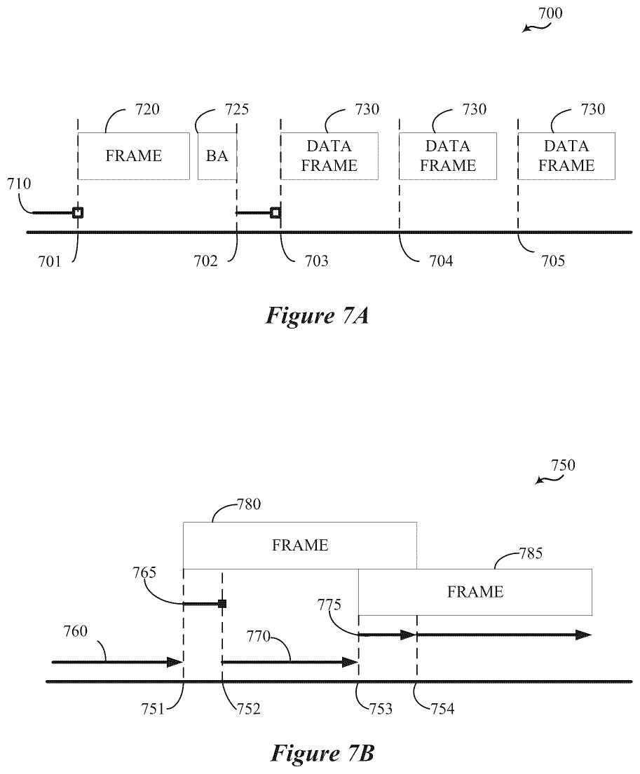

In some examples, in the configuration 600, the second portion of the network traffic connection includes a communication link 625 which includes duplicated packets representing the DL traffic, DL traffic 625a, and duplicated UL traffic representing the UL traffic, UL traffic 625b. In some examples, the duplicated traffic in the communication link 515 shown in FIG. 6A provides for increased reliability in the delivery of network traffic between the UAV 520 and the controller device 510, including in cases where increased local interference may cause some traffic between the devices to not be successfully communicated between the devices. In another example, the network traffic connection on the communication links 615 and 625 may utilize a hybrid model approach such as using one of the frame exchange processes described in relation to FIG. 7A, 7B, 8 or 9 on one of the communication links.

In configuration 650 shown in FIG. 6B, the first portion of the network traffic connection includes the DL traffic and the second portion of the network traffic connection the UL traffic for the traffic connection. For example, communication link 515 includes communication link 655 between MLD 620a and MLD 610a and communication link 665 between MLD 620b and MLD 610b. The communication link 655 includes DL traffic 655a and the link 665 includes UL traffic 665b. In some examples, the UL traffic 665b includes block acknowledgement (BA) traffic for the DL traffic 655a received via the communication link 655 at the controller device 510. In some examples, the DL traffic is transmitted to the controller device 510 on a first PHY layer, such as the communication link 655, and the UL traffic is received from the controller device 510 via a second PHY layer, such as the communication link 665.

In some examples, the devices may utilize the configuration 650 in cases where a full bandwidth is not available for a second link. For example, the communication link 665 may provide for a partial NB link, such as ˜1M-to-sub-10 MHz for UL traffic 665b. In this example, whichever link has a smaller bandwidth capability will be used for UL traffic from the controller device 510 to the UAV 520. In some examples, the bandwidth is further preserved by using BA or delayed BA in the UL traffic 665b. Additionally, in some examples, the UL traffic on the communication link 665 can be inserted near the band-edges, at inter-RU guard bands or near band-centers. In some examples, the UL traffic 665b also may utilize exclusive bands, such as band controller by government regulatory agencies, which permits only command and control data/frames, but does not allow data traffic. In some examples, this communication link configuration allows for increased reliability in the UL traffic from the controller device 510 to the UAV 520 without reallocating bandwidth or other resources from the DL traffic. Additional example frame exchanges using the configurations 600 or 650 are discussed in reference to FIGS. 7A-14.

FIGS. 7A and 7B show system flow diagrams illustrating example processes for providing communication links between multi-link network devices in a wireless network. In some aspects, in both processes 700 and 750, the UAV 520 and the controller device 510 communicate via unidirectional no acknowledgement (ACK) traffic in a dual channel frame push communication model. For example, the communication link 655 operates as a Tx only channel from the UAV 520 and a Rx only channel at the controller device 510. The communication link 665 operates as a Tx only channel from the controller device 510 and a Rx only channel at the UAV 520.

In some examples, the UAV 520, operating as a Tx device, transmits the DL traffic 655a as unidirectional no ACK traffic over the communication link 655 and the controller device 510, operating as a Tx device, transmits the UL traffic 665b as unidirectional no ACK traffic over the communication link 665. The process 700 illustrates the operations performed by both the UAV 520 and the controller device 510 when operating as a Tx device over a Tx channel.

For example, at time 701 the Tx device freezes a backoff time 710 associated with an interference condition in the respective communication link (either the communication link 655 or the communication link 665 based on which device is transmitting) and receives a frame 720 and BA 725 from an interfering network device, such as APs 502 and STAs 504. At time 702, the backoff time 710 resumes. At time 703, the Tx device transmits a packet such as data frame 730 over a respective link to an Rx device. In some examples, the Tx device, (i.e., the UAV 520 and the controller device 510) also may retransmit the data frame 730 over the Tx link when the Tx communication link is in a retransmit reception state. For example, with reference to FIG. 5, when the UAV 520 is a position C, the level of interference or distance may indicate that successful reception with one frame transmission is less likely, so the Tx device, in the retransmit reception state, retransmits the data frame 730, at times 704 and 705, to provide for a greater chance of reception at the Rx device.

In some aspects, the process 750 illustrates the operations of both the UAV 520 and the controller device 510 operating as an Rx device. For example, the Rx device at block 760 inspects a preamble of a first Overlapping Basic Service Set (OBSS) packet, such as frame 780, received at the Rx device. At time 751 and block 765, the Rx device determines the destination for the frame 780 and at time 752 aborts reception of the first OBSS packet, frame 780, when the first packet is not destined for the Rx device. At block 770, the Rx device continues inspection of preambles of additional packets received at the Rx device during an OBSS backoff time associated with the frame 780. At time 754, the Rx device begins receiving a first packet destined for the Rx device as determined by the inspection of the packet at block 775. At time 754, the Rx device continues reception of the frame 785. In some examples, the process 750 on the Rx only channel/communication link, provides for special handling of packets/frames to optimize the chance of reception of frames, such as the frame 785. For example, there is no need to continue reception of a frame not destined to this device, such as the frame 780. Additionally, there is no need to do NAV tracking as transmission on the Rx communication link will not be initiated over the designated Rx link.

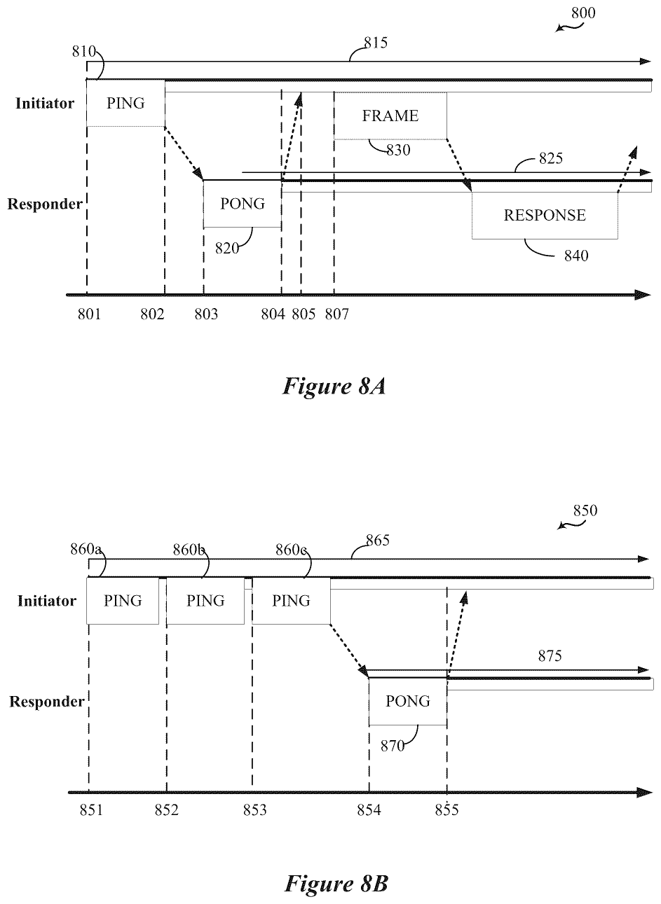

FIG. 8A shows a system flow diagram illustrating an example process 800 for providing communication links between multi-link network devices in a wireless network. In some aspects, both the UAV 520 and the controller device 510 establish or confirm that a link, including any of the links shown in FIGS. 5, 6A and 6B, is functioning. For example, the UAV 520 and the controller device 510 confirm, through handshake or ping-pong process, that a proper connection is established. This method reduces long frame transmissions between the devices, which may later be found to have not reached the target device resulting in wasted medium time. Additionally, during local reserved medium time, there are many chances to establish a proper connection if interference is causing connection problems between the devices. In some examples, the process 800 includes only sending a portion of a legacy PPDU header, which uses the legacy PPDU medium reservation time based on L-SIG, then aborts transmission and utilizes the rest of reserved PPDU time to confirm the handshake and if successful, perform the data exchange by pushing the data frame to the responder device.

For example at time 801, the initiator device generates a first portion of a packet preamble or PING, PING 810 and reserves a local medium for a PPDU duration time 815. At time 802, the initiator device transmitting to the responder device via a communication link, pauses a transmission of one or more packets from the initiator over the communication link.

At time 803, the responder device having received the PING 810, generates and transmits a response packet preamble or PONG, PONG 820, and reserves a local medium for the PPDU duration time 825. At time 804, the responder device concludes transmission of the PONG 820 to the initiator. At time 805, the initiator device receives the PONG 820 as a confirmation of successful reception of the first portion of the packet preamble (PING 810) from the responder device. In this example, the successful communication of the PING 810 and PONG 820 indicate that the connection is established between the devices and at time 807, the Initiator transmits a full frame 830 and receives a response 840 over the established/verified connection.

FIG. 8B shows a system flow diagram illustrating an example process 850 for providing communication links between multi-link network devices in a wireless network. In some aspects, both the UAV 520 and the controller device 510 establish or confirm that a link, including any of the links shown in FIGS. 5, 6A and 6B, is functioning. For example, the UAV 520 and the controller device 510 confirm, through handshake or ping-pong process, that a proper connection is established similar to the process 800 discussed in relation to FIG. 8A. In the process 850, the initiator device may repeat a ping transmission process until a pong is received.

For example at time 851, the Initiator generates a first portion of a packet preamble or PING, PING 860a and reserves a local medium for a PPDU duration time 865. The Initiator transmits to the Responder device via a communication link and pauses a transmission of one or more packets from the Initiator over the communication link.

At times 852 and 853, the Initiator retransmits the PING 860a as PINGs 860b and 860c, during the reserved PPDU time, to increase a likelihood of a PING being received at the responder device and for a PONG to be sent from the responder device. In some examples, prior to time 854, the Responder device receives the PING 860c, generates a response packet preamble or PONG, PONG 870, and reserves a local medium for the PPDU duration time 875. At time 854, the responder device transmits the PONG 870 to the Initiator and the connection is confirmed similar to the process 800 described in reference to FIG. 8A. The Initiator receives the PONG 870 as a confirmation of successful reception of the first portion of the packet preamble (PING 860c) from the responder device. In this example, the successful communication of the PING 860c and PONG 870 indicate that the connection is established between the devices and the Initiator transmits a full frame and receives a response over the established/verified connection.

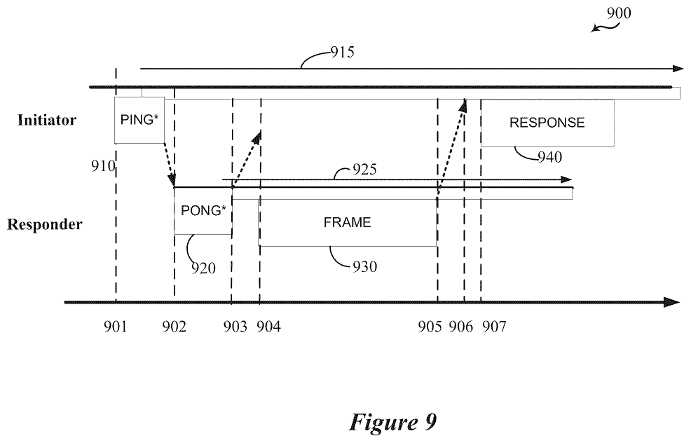

FIG. 9 shows a system flow diagram illustrating an example process 900 for providing communication links between multi-link network devices in a wireless network. In some aspects, both the UAV 520 and the controller device 510 establish or confirm that a link, including any of the links shown in FIGS. 5, 6A and 6B, is functioning. For example, the UAV 520 and the controller device 510 confirm through a very fast handshake or ping-pong pull process that a proper connection is established. This method also allows reduces long frame transmissions between the devices, which are later found to have not reached the target device resulting in wasted medium time. In some examples, the process 900 includes only sending a small portion of a legacy PPDU header with a pull designation, which uses the legacy PPDU medium reservation time based on L-SIG, then aborts transmission and use the rest of reserved PPDU time to receive data from the Rx device if the handshake is successful.

For example at time 901, the Initiator device, generates a first portion of a packet preamble with a pull designation, PING* 910 and reserves a local medium for a PPDU duration time 915. In some examples, the pull designation indicates that the medium at the Initiator device is reserved and waiting for a frame from the Responder device. Prior to time 902, the Initiator device transmitting to the Responder device via a communication link pauses a transmission of one or more packets from the Tx device over the communication link.

At time 902, the Responder device having received the PING* 910, generates a PONG* 920, and reserves a local medium for the PPDU duration time 925. At time 903, the Responder device concludes transmitting the PONG* 920 to the Initiator device and at time 904 starts transmitting a pull frame 930 to the Tx device. At or prior to time 904, the Initiating device receives the PONG* 920 as a confirmation of successful reception of the first portion of the packet preamble (PING* 910) from the Responder device and waits for the pull frame 930. Upon receiving the pull frame 930 at time 906, the Initiator device transmits the response 940 over the established/verified connection at time 907.

In some examples, for both processes 800 and 900, multiple PINGs 810 or PING*s 910 may transmit during the reserved medium times 815 and 915, in order to utilize the reserved medium to established or confirm the communication link. In some examples, the UAV 520 and the controller device 510 may utilize a hybrid model using a ping-pong process such as the processes 800 and 900 on one communication link, such as the link 615, and a dual channel frame push communication model, such as the processes 700 and 750 on a second communication link. In some examples, the Tx device may transmit PINGs or PING*s for the entirety of the reserved time or until a PONG or PONG* is received from the Rx device. In some examples, the modified preamble discussed in relation to processes 800 and 900 modify PPDU headers such as the PDU 200 and PPDU 250 discussed in relation to FIGS. 2A and 2B.

In some examples, the Tx device and Rx device also may utilize the reserved medium time to perform fast time synchronization. For example, the Tx device may transmit a beacon frame in the reserved medium including a TSF time value, where the Rx device receives the timestamp, compensates for the transmit duration, and aligns its local timer according to the TSF. In some examples, the Tx device also may use a fast time sync frame which functions as a mini-mini beacon frame and includes only a timestamp field.

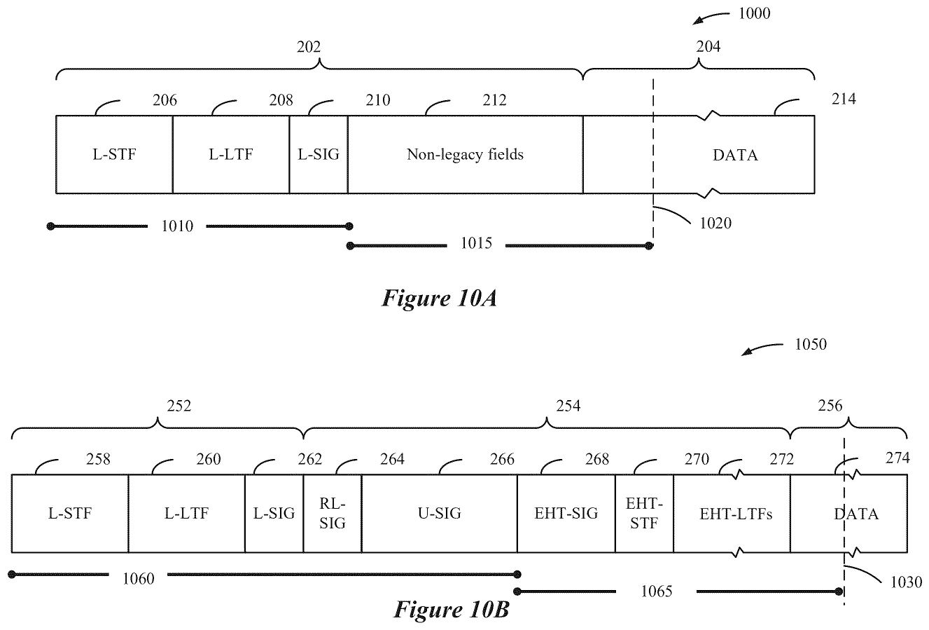

FIGS. 10A and 10B show example adjustable packet preambles usable for wireless communication. For example, the UAV 520 or the controller device 510 may include only a portion of the PDU 200 or the PPDU 250 when generating the PING and PONG packet preambles. For example, packet preamble 1000 may include the PHY preamble 202 and none or only a portion of the PHY payload 204 based on adjustable threshold 1020 for a packet extension section. Additionally, packet preamble 1050 may include the legacy portion 252, the non-legacy portion 254, and none or only a portion of the payload 256 based on adjustable threshold 1030. In some examples, an Rx device may abort reception of a preamble if the energy disappears after L-SIG 210. In some examples, the packet preamble 1000 may include some of non-legacy fields 212 and DATA 214 in order to prevent a Rx device from aborting reception of the packet preamble.

In some aspects, as the UAV 520 travels further from the controller device 510, an increasing amount of round-trip delay (Trtd) is expected in the communication link. In some examples Trtd can exceed various known quiet periods such as SIFS time or the slot-time for which some other OBSS devices (receivers) would monitor the channel after energy disappears, before resuming contention based Tx. In some examples, durations 1010 and 1060 may be extended by a duration 1015 or duration 1065.

For example, packet preamble 1000 can be extended to include Tsifs+Tslot time in the threshold 1020. In this example, the Rx device detects the information in the packet preamble 1000 and prepares for sending the PONG response even if it overlaps with the inbound extension symbols in the duration 1015. In another example, the Trtd may be continually estimated from the successfully received packets at the Tx device. Null Symbols can be appended to include Trtd, where the Null symbols carry only the carrier or unused tone(s).

In another example, a power drop can be estimated and limited based on the SNR at the Rx device such that the remote Rx device would still see the packet preamble including threshold 1020 as End-of-Packet while a local OBSS Rx device would not see this as energy disappearance and estimate the Interference Power/path loss to ensure that the leakage energy remains above a CCA threshold.

In another example, a Cyclic Redundancy Check value that is decipherable only by the UAV 520 and the controller device 510 may be added in a High Efficiency Signal header field, such as the U-SIG 266. In some examples, a rate and length combination of the LSIG field 262 may be used to indicated that a PING/PONG process, such as described in relation to FIGS. 8A, 8B and 9 is occurring between the UAV 520 and the controller device 510.

In some examples, the check value is also associated with a round-trip delay between the wireless access point and the wireless station. In some examples, the preamble 1050 also may include a packet extension section for the duration 1065 to extend an energy of the packet preamble on a medium.

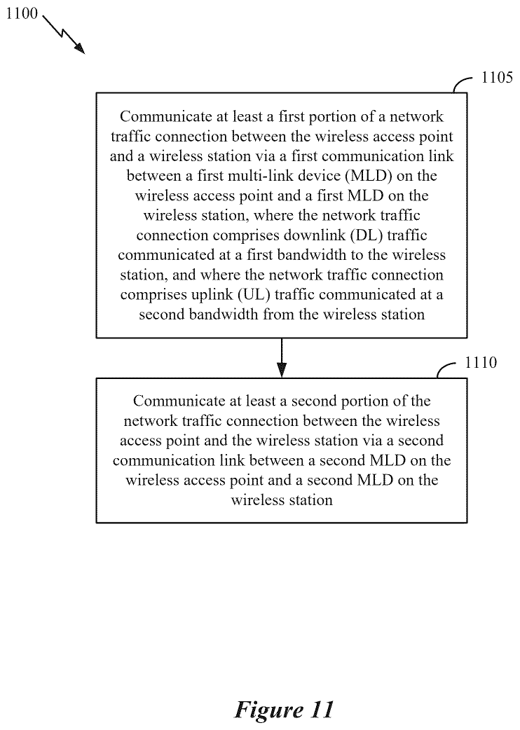

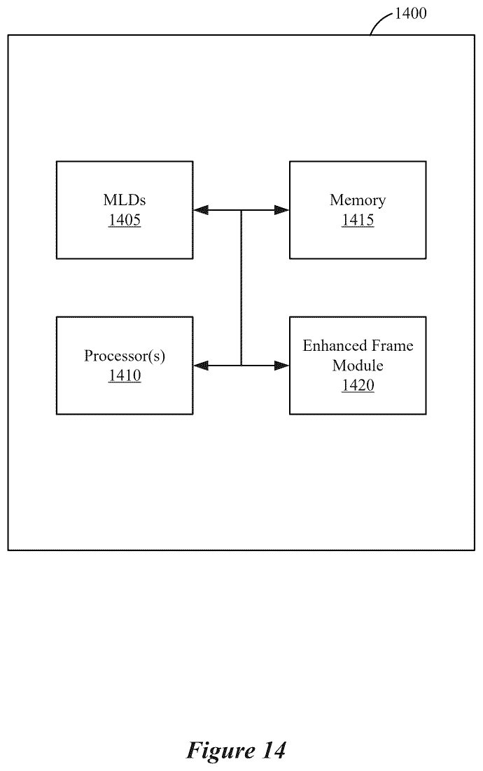

FIG. 11 shows a flowchart illustrating an example process 1100 performable by or at a wireless AP that supports providing communication links between multi-link network devices in a wireless network. The operations of the process 1100 may be implemented by a wireless AP or its components as described herein. For example, the process 1100 may be performed by a wireless communication device, such as the wireless communication device 1400 described with reference to FIG. 14, operating as or within a wireless AP. While described in relation to a wireless AP, the process 1100 also may be performed by a wireless STA. In some examples, the process 1100 may be performed by a wireless AP such as one of the APs 102 described with reference to FIG. 1 and the UAV 520 described with reference to FIGS. 5, 6A and 6B. In some examples, the process 1100 may be performed by a wireless STA such as one of the STAs 102 described with reference to FIG. 1 and the controller device 510 described with reference to FIGS. 5, 6A and 6B.

In some examples, in block 1105, the wireless AP communicates at least a first portion of a network traffic connection between the wireless access point and a wireless station via a first communication link between a first MLD on the wireless access point and a first MLD on the wireless station. In some examples, the network traffic connection includes DL traffic communicated at a first bandwidth to the wireless station, and the network traffic connection includes UL traffic communicated at a second bandwidth from the wireless station. In some examples, the first bandwidth is different from the second bandwidth. For example, the first bandwidth for the DL traffic from the UAV 520 is greater than the second bandwidth for UL traffic from the controller device 510.

At block 1110, the wireless AP communicates at least a second portion of the network traffic connection between the wireless access point and the wireless station via a second communication link between a second MLD on the wireless access point and a second MLD on the wireless station.

In some aspects, the first portion of the network traffic connection includes the DL traffic and the UL traffic the second portion of the network traffic connection includes duplicated packets representing the DL traffic and duplicated UL traffic representing the UL traffic as described in relation to the configuration 600 in FIG. 6A.

In some aspects, the first portion of the network traffic connection includes the DL traffic and the second portion of the network traffic connection the UL traffic for the traffic connection. In some examples, the UL traffic includes block acknowledgement (BA) traffic for the DL traffic received via the first communication link. In some examples, the DL traffic is transmitted to the wireless station on a first PHY layer, and the UL traffic is received from the wireless station via a second PHY layer as discussed in relation to the configuration 650 in FIG. 6B.

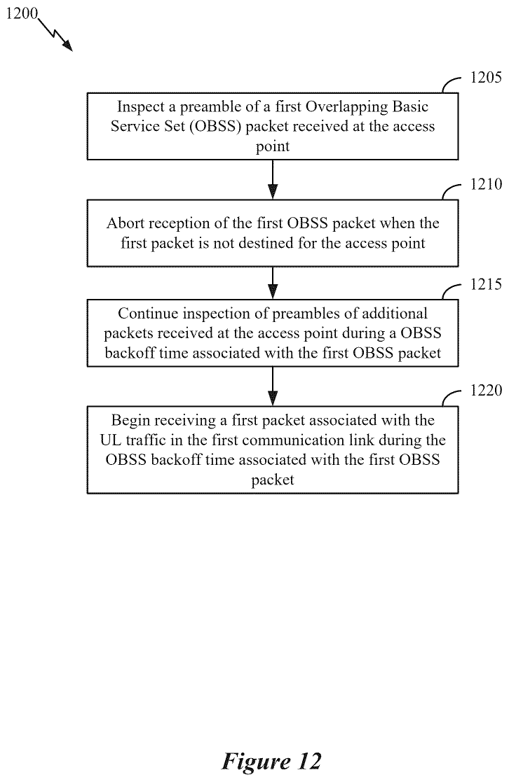

In some examples, the wireless access point transmits the DL traffic as unidirectional no acknowledgement (ACK) traffic, and the AP freezes a backoff time associated with an interference condition in the first communication link and transmits, a DL packet over the first DL link. In some examples, the AP also may retransmit the DL packet over the first DL link when the first communication link is in a retransmit reception state described with reference to FIG. 7A. In some examples, the wireless AP also receives packets/frames according to the process described in relation to FIG. 12 and FIG. 7B.

FIG. 12 shows a flowchart illustrating an example process 1200 performable by or at a wireless AP that supports providing communication links between multi-link network devices in a wireless network. The operations of the process 1200 may be implemented by a wireless AP or its components as described herein. For example, the process 1200 may be performed by a wireless communication device, such as the wireless communication device 1400 described with reference to FIG. 14, operating as or within a wireless AP. In some examples, the process 1200 may be performed by a wireless AP such as one of the APs 102 described with reference to FIG. 1 and the UAV 520 described with reference to FIGS. 5 and 6B.

In some examples, in block 1205, the wireless AP inspects a preamble of a first OBSS packet received at the access point. For example as described in reference to process 750 of FIG. 7B, the wireless AP inspects the frame 780 and determines that the frame is not destined for the wireless AP.

At block 1210, the wireless AP aborts reception of the first OBSS packet when the first packet is not destined for the access point and continues inspection of preambles of additional packets received at the access point during an OBSS backoff time associated with the first OBSS packet at block 1215. For example, with reference to FIG. 7B, the wireless AP continues inspecting packet preambles at times 752 through 753.

At block 1220, the wireless AP begins receiving a first packet associated with the UL traffic in the first communication link during the OBSS backoff time associated with the first OBSS packet. For example, the wireless AP begins/continues receiving the frame 785 shown in FIG. 7B upon determining the frame 785 is destined for the wireless AP at time 754.

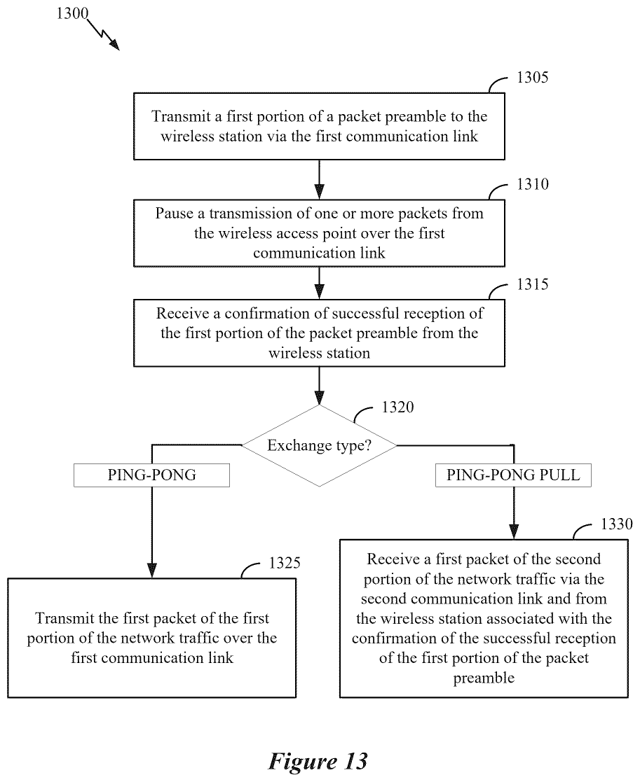

FIG. 13 shows a flowchart illustrating an example process 1300 performable by or at a wireless AP that supports providing communication links between multi-link network devices in a wireless network. The operations of the process 1300 may be implemented by a wireless AP or its components as described herein. For example, the process 1300 may be performed by a wireless communication device, such as the wireless communication device 1400 described with reference to FIG. 14, operating as or within a wireless AP. In some examples, the process 1300 may be performed by a wireless AP such as one of the APs 102 described with reference to FIG. 1 and the UAV 520 described with reference to FIGS. 5 and 6B.

In some examples, in block 1305, the wireless AP transmits a first portion of a packet preamble to the wireless station via the first communication link. For example, with reference to FIGS. 8 and 9, the wireless AP transits a PING 810 or PING* 910.

At block 1310, the wireless AP pauses a transmission of one or more packets from the wireless access point over the first communication link. For example, with reference to FIGS. 8 and 9, at times 802 and 902, the wireless AP pauses transmission and reserves the medium for a duration of time.

At block 1315, the wireless AP receives a confirmation of successful reception of the first portion of the packet preamble from the wireless station. For example, with reference to FIGS. 8 and 9, the wireless AP receives a PONG 820 or PONG* 920.

At block 1320, the wireless AP determines a type for the frame exchange. For example, for a ping-pong exchange type the process 1300 proceeds to block 1325 where the wireless AP transmits the first packet of the first portion of the network traffic over the first communication link. For example, the wireless AP transmits the frame 830 as described with reference to FIG. 8A.

In some examples, the frame exchange type is a ping-pong pull and the process 1300 proceeds to block 1330 where the wireless AP receives a first packet of the second portion of the network traffic via the second communication link and from the wireless station associated with the confirmation of the successful reception of the first portion of the packet preamble. For example, the wireless AP receives the frame 930 as described with reference to FIG. 9.

FIG. 14 shows a block diagram of an example wireless communication device 1400 that supports providing communication links between multi-link network devices. In some examples, the wireless communication device 1400 includes various device components or modules including an MLDs 1405, a processor(s) 1410, a memory 1415 and an enhanced frame module 1420. The wireless communication device 1400 may include one or more chips, SoCs, chipsets, packages, components or devices that individually or collectively constitute or include a processing system. The processing system may interface with other components of the wireless communication device 1400 and may generally process information (such as inputs or signals) received from such other components and output information (such as outputs or signals) to such other components. In some aspects, an example chip may include a processing system, a first interface to output or transmit information and a second interface to receive or obtain information. For example, the first interface may refer to an interface between the processing system of the chip and a transmission component, such that the device 1400 may transmit the information output from the chip. In such an example, the second interface may refer to an interface between the processing system of the chip and a reception component, such that the device 1400 may receive information that is passed to the processing system. In some such examples, the first interface also may obtain information, such as from the transmission component and the second interface also may output information, such as to the reception component.

The processing system of the wireless communication device 1400 includes processor (or “processing”) circuitry in the form of one or multiple processors, microprocessors, processing units (such as central processing units (CPUs), graphics processing units (GPUs), neural processing units (NPUs) (also referred to as neural network processors or deep learning processors (DLPs)), or digital signal processors (DSPs)), processing blocks, application-specific integrated circuits (ASIC), programmable logic devices (PLDs) (such as field programmable gate arrays (FPGAs)), or other discrete gate or transistor logic or circuitry (all of which may be generally referred to herein individually as “processors” or collectively as “the processor” or “the processor circuitry”). One or more of the processors may be individually or collectively configurable or configured to perform various functions or operations described herein. The processing system may further include memory circuitry in the form of one or more memory devices, memory blocks, memory elements or other discrete gate or transistor logic or circuitry, each of which may include tangible storage media such as random-access memory (RAM) or read-only memory (ROM), or combinations thereof (all of which may be generally referred to herein individually as “memories” or collectively as “the memory” or “the memory circuitry”). One or more of the memories may be coupled with one or more of the processors and may individually or collectively store processor-executable code that, when executed by one or more of the processors, may configure one or more of the processors to perform various functions or operations described herein. Additionally or alternatively, in some examples, one or more of the processors may be preconfigured to perform various functions or operations described herein without requiring configuration by software. The processing system may further include or be coupled with one or more modems (such as a Wi-Fi (for example, IEEE compliant) modem or a cellular (for example, 3GPP 4G LTE, 5G or 6G compliant) modem). In some implementations, one or more processors of the processing system include or implement one or more of the modems. The processing system may further include or be coupled with multiple radios (collectively “the radio”), multiple RF chains or multiple transceivers, each of which may in turn be coupled with one or more of multiple antennas. In some implementations, one or more processors of the processing system include or implement one or more of the radios, RF chains or transceivers.

In some examples, the wireless communication device 1400 can be configurable or configured for use in an AP, such as the AP 102 described with reference to FIG. 1 and the UAV 520 described with reference to FIG. 5. In some other examples, the wireless communication device 1400 can be an AP that includes such a processing system and other components including multiple antennas or MLDs 1405. The wireless communication device 1400 is capable of transmitting and receiving wireless communications in the form of, for example, wireless packets. For example, the wireless communication device 1400 can be configurable or configured to transmit and receive packets in the form of physical layer PPDUs and MPDUs conforming to one or more of the IEEE 802.11 family of wireless communication protocol standards. In some other examples, the wireless communication device 1400 can be configurable or configured to transmit and receive signals and communications conforming to one or more 3GPP specifications including those for 5G NR or 6G. In some examples, the wireless communication device 1400 also includes or can be coupled with one or more application processors which may be further coupled with one or more other memories. In some examples, the wireless communication device 1400 further includes at least one external network interface coupled with the processing system that enables communication with a core network or backhaul network that enables the wireless communication device 1400 to gain access to external networks including the Internet.

Portions of one or more of the components 1405-1420 may be implemented at least in part in hardware or firmware. For example, the components 1405 and 1420 may be implemented at least in part by a processor or a modem. In some examples, portions of one or more of the components 1415 and 1420 may be implemented at least in part by a processor and software in the form of processor-executable code stored in a memory.

Implementation examples are described in the following numbered clauses:

Clause 1. A wireless access point, including: a processing system that includes one or more processors and one or more memories coupled with the one or more processors, the processing system configured to cause the wireless access point to: communicate at least a first portion of a network traffic connection between the wireless access point and a wireless station via a first communication link between a first multi-link device (MLD) on the wireless access point and a first MLD on the wireless station, where the network traffic connection includes downlink (DL) traffic communicated at a first bandwidth to the wireless station, and where the network traffic connection includes uplink (UL) traffic communicated at a second bandwidth from the wireless station; and communicate at least a second portion of the network traffic connection between the wireless access point and the wireless station via a second communication link between a second MLD on the wireless access point and a second MLD on the wireless station.

Clause 2. The wireless access point of clause 1, where the first portion of the network traffic connection includes: the DL traffic; and the UL traffic; and where the second portion of the network traffic connection includes: duplicated packets representing the DL traffic; and duplicated UL traffic representing the UL traffic.

Clause 3. The wireless access point of any of clauses 1 or 2, where the first portion of the network traffic connection includes: the DL traffic; and where the second portion of the network traffic connection includes: the UL traffic.

Clause 4. The wireless access point of any of clauses 1, 2 or 3, where the UL traffic includes block acknowledgement (BA) traffic for the DL traffic received via the first communication link.

Clause 5. The wireless access point of any of clauses 1, 2 or 3, where the DL traffic is transmitted to the wireless station on a first physical (PHY) layer, and where the UL traffic is received from the wireless station via a second PHY layer.

Clause 6. The wireless access point of any of clauses 1, 2 or 3, where the wireless access point transmits the DL traffic as unidirectional no acknowledgement (ACK) traffic, and where the processing system is further configured to cause the wireless access point to: freeze a backoff time associated with an interference condition in the first communication link; and transmit, during the backoff time, a DL packet over the first communication link.

Clause 7. The wireless access point of any of clauses 1, 2, 3 or 6, where the processing system is further configured to cause the wireless access point to: retransmit the DL packet over the first communication link when the first communication link is in a retransmit reception state.

Clause 8. The wireless access point of any of clauses 1, 2, 3, 6 or 7, where the processing system is further configured to cause the wireless access point to: inspect a preamble of a first Overlapping Basic Service Set (OBSS) packet received at the access point; abort reception of the first OBSS packet when the first packet is not destined for the access point; continue inspection of preambles of additional packets received at the access point during a OBSS backoff time associated with the first OBSS packet; and begin receiving a first packet associated with the UL traffic in the first communication link during the OBSS backoff time associated with the first OBSS packet.

Clause 9. The wireless access point of clauses 1, 2, 3, 6, 7 or 8, where the wireless access point transmits the DL traffic as unidirectional no ACK traffic, and where the wireless access point communicates the UL traffic via the second communication link using a ping-pong pull network traffic exchange.

Clause 10. The wireless access point of clause 1, where the processing system is further configured to cause the wireless access point to: transmit a first portion of a packet preamble to the wireless station via the first communication link; pause a transmission of one or more packets from the wireless access point over the first communication link; and receive a confirmation of successful reception of the first portion of the packet preamble from the wireless station.

Clause 11. The wireless access point of any of clauses 1 or 10, where the first portion of the packet preamble indicates a ping-pong network traffic exchange between the wireless access point and the wireless station for a first packet of the first portion of the network traffic connection, and where the processing system is further configured to cause the wireless access point to: transmit the first packet of the first portion of the network traffic connection over the first communication link.

Clause 12. The wireless access point of any of clauses 1, 10 or 11, where the first portion of the packet preamble indicates a ping-pong pull network traffic exchange between the wireless access point and the wireless station, and where the processing system is further configured to cause the wireless access point to: receive a first packet of the second portion of the network traffic connection via the second communication link and from the wireless station associated with the confirmation of the successful reception of the first portion of the packet preamble.

Clause 13. The wireless access point of any of clauses 1, 10, 11 or 12, where the first portion of the packet preamble includes at least: a combination of values in a header rate field and a header length field indicating one of a ping-pong network traffic exchange or a ping-pong pull network traffic exchange between the wireless access point and the wireless station; and a reservation portion to reserve a local medium for the ping-pong network traffic exchange or the ping-pong pull network traffic exchange.

Clause 14. The wireless access point of any of any of clauses 1, 10, 11, 12 or 13, where the reservation portion includes: a first amount of packet data, where a size of the first amount of the packet data is associated with a round-trip delay between the wireless access point and the wireless station.

Clause 15. The wireless access point of clauses 1, 10, 11, 12, 13 or 14, where the first portion includes one or more of: a Cyclic Redundancy Check value in a High Efficiency Signal header field and associated with a round-trip delay between the wireless access point and the wireless station; and a packet extension section to extend an energy of the packet preamble on a medium.

Clause 16. The wireless access point of any of clauses 1, 2, 3, 4, 5, 6, 7, 8, 9, 10, 11, 12, 13, 14 or 15, where the wireless access point includes an uncrewed aerial vehicle (UAV), and where the wireless station includes a UAV controller.

Clause 17. A wireless station, including: a processing system that includes one or more processors and one or more memories coupled with the one or more processors, the processing system configured to cause the wireless station to: communicate at least a first portion of a network traffic connection between the wireless station and a wireless access point (AP) via a first communication link between a first multi-link device (MLD) on the wireless station and a first MLD on the wireless access point, where the network traffic connection includes downlink (DL) traffic communicated at a first bandwidth from the wireless AP, and where the network traffic connection includes uplink (UL) traffic communicated at a second bandwidth to the wireless AP from the wireless station; and communicate at least a second portion of the network traffic connection between the wireless station and the wireless AP via a second communication link between a second MLD on the wireless station and a second MLD on the wireless AP.

Clause 18. The wireless station of clause 17, where the first portion of the network traffic connection includes: the DL traffic; and the UL traffic; and where the second portion of the network traffic connection includes: duplicated packets representing the DL traffic; and duplicated UL traffic representing the UL traffic.

Clause 19. The wireless station of any of clauses 17 or 18, where the processing system is further configured to cause the wireless station to: randomly assign resource units (RUS) to the UL traffic and the duplicated UL traffic to provide increased reliability in the network traffic connection.

Clause 20. The wireless station of any of clauses 17, 18, or 19, where the first portion of the network traffic connection includes: the DL traffic; and where the second portion of the network traffic connection includes: the UL traffic.

Clause 21. The wireless station of any of clauses 17, 18, 19 or 20, where the UL traffic includes block acknowledgement (BA) traffic for the DL traffic received via the first communication link.

Clause 22. The wireless station of any of clauses 17, 18, 19, 20 or 21, where the DL traffic is transmitted from the wireless AP on a first physical (PHY) layer, and where the UL traffic is transmitted to the wireless AP via a second PHY layer.

Clause 23. The wireless station of any of clauses 17, 18, 19, 20, 21 or 22, where the wireless station transmits the UL traffic as unidirectional no acknowledgement (ACK) traffic, and where the processing system is further configured to cause the wireless station to: freeze a backoff time associated with an interference condition in the first communication link; and transmit, during the backoff time, a UL packet over the first communication link.

Clause 24. The wireless station of any of clauses 17, 18, 19, 20, 21, 22 or 23, where the processing system is further configured to cause the wireless station to: inspect a preamble of a first Overlapping Basic Service Set (OBSS) packet received at the wireless station; abort reception of the first OBSS packet when the first OBSS packet is not destined for the wireless station; continue inspection of preambles of additional packets received at the wireless station during a OBSS backoff time associated with the first OBSS packet; and begin receiving a first packet associated with the DL traffic during the backoff time associated with the first packet.

Clause 25. The wireless station of any of clauses 17, 18, 19, 20, 21, 22, 23 or 24, where the processing system is further configured to cause the wireless station to: transmit a first portion of a packet preamble to the wireless AP, where the first portion of the packet preamble includes: a combination of values in a header rate field and a header length field indicating one of a ping-pong network traffic exchange or a ping-pong pull network traffic exchange between the wireless AP and the wireless station; and a reservation portion to reserve a local medium for the ping-pong exchange or a ping-pong pull exchange; pause a transmission of one or more packets from the wireless station; receive a confirmation of successful reception of the first portion of the packet preamble from the wireless AP.

Clause 26. A method for wireless communication by a wireless communication device, including: communicating at least a first portion of a network traffic connection between the wireless communication device and a wireless station via a first communication link between a first multi-link device (MLD) on the wireless communication device and a first MLD on the wireless station, where the network traffic connection includes downlink (DL) traffic communicated at a first bandwidth to the wireless station, and where the network traffic connection includes uplink (UL) traffic communicated at a second bandwidth from the wireless station; and communicating at least a second portion of the network traffic connection between the wireless communication device and the wireless station via a second communication link between a second MLD on the wireless communication device and a second MLD on the wireless station.

Clause 27. The method of clause 26, where the first portion of the network traffic connection includes: the DL traffic; and the UL traffic; and where the second portion of the network traffic connection includes: duplicated packets representing the DL traffic; and duplicated UL traffic representing the UL traffic.

Clause 28. The method of any of clauses 26 or 27, where the first portion of the network traffic connection includes: the DL traffic; and where the second portion of the network traffic connection includes: the UL traffic.

Clause 29. A method for wireless communication by a wireless station, including: communicating at least a first portion of a network traffic connection between the wireless station and a wireless access point (AP) via a first communication link between a first multi-link device (MLD) on the wireless station and a first MLD on the wireless access point, where the network traffic connection includes downlink (DL) traffic communicated at a first bandwidth from the wireless AP, and where the network traffic connection includes uplink (UL) traffic communicated at a second bandwidth to the wireless AP from the wireless station; and communicating at least a second portion of the network traffic connection between the wireless station and the wireless AP via a second communication link between a second MLD on the wireless station and a second MLD on the wireless AP.

Clause 30. The method of clause 29, where the first portion of the network traffic connection includes: the DL traffic; and the UL traffic; and where the second portion of the network traffic connection includes: duplicated packets representing the DL traffic; and duplicated UL traffic representing the UL traffic.

As used herein, the term “determine” or “determining” encompasses a wide variety of actions and, therefore, “determining” can include calculating, computing, processing, deriving, estimating, investigating, looking up (such as via looking up in a table, a database, or another data structure), inferring, ascertaining, or measuring, among other possibilities. Also, “determining” can include receiving (such as receiving information), accessing (such as accessing data stored in memory) or transmitting (such as transmitting information), among other possibilities. Additionally, “determining” can include resolving, selecting, obtaining, choosing, establishing and other such similar actions.

As used herein, a phrase referring to “at least one of” or “one or more of” a list of items refers to any combination of those items, including single members. As an example, “at least one of: a, b, or c” is intended to cover: a, b, c, a-b, a-c, b-c, and a-b-c. As used herein, “or” is intended to be interpreted in the inclusive sense, unless otherwise explicitly indicated. For example, “a or b” may include a only, b only, or a combination of a and b. Furthermore, as used herein, a phrase referring to “a” or “an” element refers to one or more of such elements acting individually or collectively to perform the recited function(s). Additionally, a “set” refers to one or more items, and a “subset” refers to less than a whole set, but non-empty.

As used herein, “based on” is intended to be interpreted in the inclusive sense, unless otherwise explicitly indicated. For example, “based on” may be used interchangeably with “based at least in part on,” “associated with,” “in association with,” or “in accordance with” unless otherwise explicitly indicated. Specifically, unless a phrase refers to “based on only ‘a,’” or the equivalent in context, whatever it is that is “based on ‘a,’” or “based at least in part on ‘a,’” may be based on “a” alone or based on a combination of “a” and one or more other factors, conditions, or information.

The various illustrative components, logic, logical blocks, modules, circuits, operations, and algorithm processes described in connection with the examples disclosed herein may be implemented as electronic hardware, firmware, software, or combinations of hardware, firmware, or software, including the structures disclosed in this specification and the structural equivalents thereof. The interchangeability of hardware, firmware and software has been described generally, in terms of functionality, and illustrated in the various illustrative components, blocks, modules, circuits and processes described above. Whether such functionality is implemented in hardware, firmware or software depends upon the particular application and design constraints imposed on the overall system.

Various modifications to the examples described in this disclosure may be readily apparent to persons having ordinary skill in the art, and the generic principles defined herein may be applied to other examples without departing from the spirit or scope of this disclosure. Thus, the claims are not intended to be limited to the examples shown herein, but are to be accorded the widest scope consistent with this disclosure, the principles and the novel features disclosed herein.

Additionally, various features that are described in this specification in the context of separate examples also can be implemented in combination in a single implementation. Conversely, various features that are described in the context of a single implementation also can be implemented in multiple examples separately or in any suitable subcombination. As such, although features may be described above as acting in particular combinations, and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one or more example processes in the form of a flowchart or flow diagram. However, other operations that are not depicted can be incorporated in the example processes that are schematically illustrated. For example, one or more additional operations can be performed before, after, simultaneously, or between any of the illustrated operations. In some circumstances, multitasking and parallel processing may be advantageous. Moreover, the separation of various system components in the examples described above should not be understood as requiring such separation in all examples, and it should be understood that the described program components and systems can generally be integrated together in a single software product or packaged into multiple software products.

What is claimed is:

1. A wireless access point, comprising:
a processing system that includes one or more processors and one or more memories coupled with the one or more processors, the processing system configured to cause the wireless access point to:
communicate at least a first portion of a network traffic connection between the wireless access point and a wireless station via a first communication link between a first multi-link device (MLD) on the wireless access point and a first MLD on the wireless station, where the network traffic connection comprises downlink (DL) traffic communicated at a first bandwidth to the wireless station, and where the network traffic connection comprises uplink (UL) traffic communicated at a second bandwidth from the wireless station; and
communicate at least a second portion of the network traffic connection between the wireless access point and the wireless station via a second communication link between a second MLD on the wireless access point and a second MLD on the wireless station.

2. The wireless access point of claim 1,
wherein the first portion of the network traffic connection comprises:
the DL traffic; and
the UL traffic; and
wherein the second portion of the network traffic connection comprises:
duplicated packets representing the DL traffic; and
duplicated UL traffic representing the UL traffic.

3. The wireless access point of claim 1,
wherein the first portion of the network traffic connection comprises:
the DL traffic; and
wherein the second portion of the network traffic connection comprises:
the UL traffic.

4. The wireless access point of claim 3, wherein the UL traffic comprises block acknowledgement (BA) traffic for the DL traffic received via the first communication link.

5. The wireless access point of claim 3, wherein the DL traffic is transmitted to the wireless station on a first physical (PHY) layer, and wherein the UL traffic is received from the wireless station via a second PHY layer.

6. The wireless access point of claim 3, wherein the wireless access point transmits the DL traffic as unidirectional no acknowledgement (ACK) traffic, and wherein the processing system is further configured to cause the wireless access point to:
freeze a backoff time associated with an interference condition in the first communication link; and
transmit, during the backoff time, a DL packet over the first communication link.

7. The wireless access point of claim 6, the processing system is further configured to cause the wireless access point to:
retransmit the DL packet over the first communication link when the first communication link is in a retransmit reception state.

8. The wireless access point of claim 3, wherein the processing system is further configured to cause the wireless access point to:
inspect a preamble of a first Overlapping Basic Service Set (OBSS) packet received at the access point;
abort reception of the first OBSS packet when the first packet is not destined for the access point;
continue inspection of preambles of additional packets received at the access point during a OBSS backoff time associated with the first OBSS packet; and
begin receiving a first packet associated with the UL traffic in the first communication link during the OBSS backoff time associated with the first OBSS packet.

9. The wireless access point of claim 3, wherein the wireless access point transmits the DL traffic as unidirectional no ACK traffic, and wherein the wireless access point communicates the UL traffic via the second communication link using a ping-pong pull network traffic exchange.

10. The wireless access point of claim 1, wherein the processing system is further configured to cause the wireless access point to:
transmit a first portion of a packet preamble to the wireless station via the first communication link;
pause a transmission of one or more packets from the wireless access point over the first communication link; and
receive a confirmation of successful reception of the first portion of the packet preamble from the wireless station.

11. The wireless access point of claim 10, wherein the first portion of the packet preamble indicates a ping-pong network traffic exchange between the wireless access point and the wireless station for a first packet of the first portion of the network traffic connection, and wherein the processing system is further configured to cause the wireless access point to:
transmit the first packet of the first portion of the network traffic connection over the first communication link.

12. The wireless access point of claim 10, wherein the first portion of the packet preamble indicates a ping-pong pull network traffic exchange between the wireless access point and the wireless station, and wherein the processing system is further configured to cause the wireless access point to:
receive a first packet of the second portion of the network traffic connection via the second communication link and from the wireless station associated with the confirmation of the successful reception of the first portion of the packet preamble.

13. The wireless access point of claim 10, wherein the first portion of the packet preamble comprises at least:
a combination of values in a header rate field and a header length field indicating one of a ping-pong network traffic exchange or a ping-pong pull network traffic exchange between the wireless access point and the wireless station; and
a reservation portion to reserve a local medium for the ping-pong network traffic exchange or the ping-pong pull network traffic exchange.

14. The wireless access point of claim 13, wherein the reservation portion comprises:
a first amount of packet data, wherein a size of the first amount of the packet data is associated with a round-trip delay between the wireless access point and the wireless station.

15. The wireless access point of claim 10, wherein the first portion comprises one or more of:
a Cyclic Redundancy Check value in a High Efficiency Signal header field and associated with a round-trip delay between the wireless access point and the wireless station; and
a packet extension section to extend an energy of the packet preamble on a medium.

16. The wireless access point of claim 1, wherein the wireless access point comprises an uncrewed aerial vehicle (UAV), and wherein the wireless station comprises a UAV controller.

17. A wireless station, comprising:
a processing system that includes one or more processors and one or more memories coupled with the one or more processors, the processing system configured to cause the wireless station to:
communicate at least a first portion of a network traffic connection between the wireless station and a wireless access point (AP) via a first communication link between a first multi-link device (MLD) on the wireless station and a first MLD on the wireless access point, where the network traffic connection comprises downlink (DL) traffic communicated at a first bandwidth from the wireless AP, and where the network traffic connection comprises uplink (UL) traffic communicated at a second bandwidth to the wireless AP from the wireless station; and
communicate at least a second portion of the network traffic connection between the wireless station and the wireless AP via a second communication link between a second MLD on the wireless station and a second MLD on the wireless AP.

18. The wireless station of claim 17,
wherein the first portion of the network traffic connection comprises:
the DL traffic; and
the UL traffic; and
wherein the second portion of the network traffic connection comprises:
duplicated packets representing the DL traffic; and
duplicated UL traffic representing the UL traffic.

19. The wireless station of claim 18, wherein the processing system is further configured to cause the wireless station to:
randomly assign resource units (RUs) to the UL traffic and the duplicated UL traffic to provide increased reliability in the network traffic connection.

20. The wireless station of claim 17,
wherein the first portion of the network traffic connection comprises:
the DL traffic; and
wherein the second portion of the network traffic connection comprises:
the UL traffic.

21. The wireless station of claim 20, wherein the UL traffic comprises block acknowledgement (BA) traffic for the DL traffic received via the first communication link.

22. The wireless station of claim 20, wherein the DL traffic is transmitted from the wireless AP on a first physical (PHY) layer, and wherein the UL traffic is transmitted to the wireless AP via a second PHY layer.

23. The wireless station of claim 20, wherein the wireless station transmits the UL traffic as unidirectional no acknowledgement (ACK) traffic, and wherein the processing system is further configured to cause the wireless station to:
freeze a backoff time associated with an interference condition in the first communication link; and
transmit, during the backoff time, a UL packet over the first communication link.

24. The wireless station of claim 20, wherein the processing system is further configured to cause the wireless station to:
inspect a preamble of a first Overlapping Basic Service Set (OBSS) packet received at the wireless station;
abort reception of the first OBSS packet when the first OBSS packet is not destined for the wireless station;
continue inspection of preambles of additional packets received at the wireless station during a OBSS backoff time associated with the first OBSS packet; and
begin receiving a first packet associated with the DL traffic during the backoff time associated with the first packet.

25. The wireless station of claim 17, wherein the processing system is further configured to cause the wireless station to:
transmit a first portion of a packet preamble to the wireless AP, wherein the first portion of the packet preamble comprises:
a combination of values in a header rate field and a header length field indicating one of a ping-pong network traffic exchange or a ping-pong pull network traffic exchange between the wireless AP and the wireless station; and
a reservation portion to reserve a local medium for the ping-pong exchange or a ping-pong pull exchange;
pause a transmission of one or more packets from the wireless station;
receive a confirmation of successful reception of the first portion of the packet preamble from the wireless AP.

26. A method for wireless communication by a wireless communication device, comprising:
communicating at least a first portion of a network traffic connection between the wireless communication device and a wireless station via a first communication link between a first multi-link device (MLD) on the wireless communication device and a first MLD on the wireless station, where the network traffic connection comprises downlink (DL) traffic communicated at a first bandwidth to the wireless station, and where the network traffic connection comprises uplink (UL) traffic communicated at a second bandwidth from the wireless station; and
communicating at least a second portion of the network traffic connection between the wireless communication device and the wireless station via a second communication link between a second MLD on the wireless communication device and a second MLD on the wireless station.

27. The method of claim 26,
wherein the first portion of the network traffic connection comprises:
the DL traffic; and
the UL traffic; and
wherein the second portion of the network traffic connection comprises:
duplicated packets representing the DL traffic; and
duplicated UL traffic representing the UL traffic.

28. The method of claim 26,
wherein the first portion of the network traffic connection comprises:
the DL traffic; and
wherein the second portion of the network traffic connection comprises:
the UL traffic.

29. A method for wireless communication by a wireless station, comprising:
communicating at least a first portion of a network traffic connection between the wireless station and a wireless access point (AP) via a first communication link between a first multi-link device (MLD) on the wireless station and a first MLD on the wireless access point, where the network traffic connection comprises downlink (DL) traffic communicated at a first bandwidth from the wireless AP, and where the network traffic connection comprises uplink (UL) traffic communicated at a second bandwidth to the wireless AP from the wireless station; and
communicating at least a second portion of the network traffic connection between the wireless station and the wireless AP via a second communication link between a second MLD on the wireless station and a second MLD on the wireless AP.

30. The method of claim 29,
wherein the first portion of the network traffic connection comprises:
the DL traffic; and
the UL traffic; and
wherein the second portion of the network traffic connection comprises:
duplicated packets representing the DL traffic; and
duplicated UL traffic representing the UL traffic.
